(19) United States
(12) Patent Application Publication
(10) Pub. No.: US 2026/0046136 A1
(43) Pub. Date: Feb. 12, 2026

(54) BIOMETRICALLY SIGNED CRYPTOGRAPHICALLY VERIFIABLE BLOCKCHAIN-ANCHORED CONTRACTS EXECUTED ON A PRIVACY-AWARE MESSAGING PLATFORM

(71) Applicant: Amod Ashok Dange, Mountain View, CA (US)

(72) Inventor: Amod Ashok Dange, Mountain View, CA (US)

(21) Appl. No.: 19/361,234

(22) Filed: Oct. 17, 2025

Related U.S. Application Data
(63) Continuation-in-part of application No. 18/535,512, filed on Dec. 11, 2023, now Pat. No. 12,476,814.
(60) Provisional application No. 63/431,753, filed on Dec. 12, 2022.

(51) Int. Cl. H04L 9/32; H04L 9/00

(52) U.S. Cl. CPC H04L 9/3231; H04L 9/3263; H04L 9/50

(57) ABSTRACT

A system and method for executing biometrically signed, cryptographically verifiable, blockchain-anchored contracts on a privacy-aware messaging platform is disclosed. The system registers users biometrically and business entities with verified communication addresses. A business-customer account is created by generating a cryptographic key-value pair comprising a customer public key and private key, creating a customer communication address, generating a business-customer communication address hash by applying a hashing algorithm to a combination of the business communication address and customer communication address, and storing a record comprising the hash and customer public key. The system receives a target document, affixes biometric signatures or the signatories, and transmits the document via an encrypted communication channel by extracting communication addresses, generating and comparing the address hashes, encrypting the document using the customer public key upon hash matching, and transmitting it to the signatories. The countersigned document is stored on a blockchain for storage.

### CROSS-REFERENCE TO RELATED APPLICATIONS AND PRIORITY

The present application is a Continuation in Part (CIP) application of U.S. application Ser. No. 18/535,512, filed on Dec. 11, 2023 entitled “System and method of privacy-aware inter-channel communication between a business entity and a person”, which claims priority from U.S. Provisional Application No. 63/431,753 filed on Dec. 12, 2022, entitled “METHOD OF INTEROPERATING BETWEEN EMAIL, TEXT MESSAGING, AND INSTANT MESSAGING”.

### TECHNICAL FIELD

The present subject matter described herein, in general, relates to a field of secure digital contract execution. More particularly, the present subject matter discloses a system and method for executing biometrically signed, cryptographically verifiable, blockchain-anchored contracts on a privacy-aware messaging platform.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In the field of digital communication and contract execution, several technologies are employed to facilitate transactions between businesses and individuals. These technologies often include email services, SMS gateways, and instant messaging applications. Businesses and individuals typically rely on these separate communication channels to connect with their intended recipients for contract-related exchanges. However, the current landscape of digital contract execution is fraught with numerous security, privacy, and authenticity challenges that have persisted since the advent of electronic communications.

Since its invention in 1971, email has become the go-to channel for asynchronous business communication and contract transmission. Its ubiquity has driven down its cost to almost nothing. However, the nonstop deluge of emails flooding the internet has created significant problems for contract-related communications. In 2021, a whopping 319.6 billion emails were transmitted daily, and 45.37% of them were spam. The carbon footprint of an email varies from 0.3 g CO2e for a spam email to 4 g CO2e for a regular email and 50 g CO2e for one with a photo or large attachment. Additionally, nearly 96% of phishing attacks are conducted using email, creating substantial risks for contract-related communications. Businesses are also under business email compromise (BEC) attack, with 77% facing scams like payroll-redirection and supplier-invoicing fraud. These attacks cost businesses an average of $5.96 million per year. To make matters worse, 83% of organizations fell for phishing attacks in 2021, compromising the security of sensitive contract information.

Text messaging, invented in 1992, is another popular way people communicate in the modern contract execution environment. But spam texts have also been on the rise, affecting contract-related communications. From 2020 to 2021, there was a 58% increase in spam texts. In September 2021, 1.227 million spam texts were sent, jumping to 10.89 billion in August 2022. In 2021, people got bombarded with spam, receiving around 41 spam texts per month. One in three Americans have been tricked by SMS scams, and only 35% of people realized that they were being targeted, creating significant vulnerabilities in contract communications.

The contact list presents perhaps the greatest vulnerability when it comes to privacy in contract execution. Email and phone number protocols were designed in an era when privacy was not a concern. Therefore, any number of people can reach a person at the same email address or phone number used for contract purposes. There is no exclusive 1:1 messaging permission structure for contract-related communications. You can only block someone after they have successfully sent you unsolicited messages. Critically, your email address and phone number can easily be revealed (willfully or inadvertently) by anyone whose contact lists you appear in. There is no mechanism to enable people to meaningfully control who sees their contact information used for business transactions.

Traditionally, software applications for contract execution require people to provide their identity as well as personal information in order to receive personalized services. However, this practice has resulted in several undesirable outcomes for contract security. People end up creating different profiles for each contract platform such as DocuSign, Adobe Sign, HelloSign, etc. As the number of profiles increases, it becomes difficult to manage these profiles for contract purposes. On average, an online user has 7.6 social media accounts, and many contract platforms require similar account creation. Many of these online profiles are created using fake identities. An estimated 30% of profiles on social media are based on fake identities, creating risks for contract authenticity. Moreover, in the existing contract execution platforms, there is no barrier to keep a user from creating a profile that corresponds to someone other than themselves. Furthermore, users don't always have control over their online profile's visibility to others within or outside of their own network when executing contracts. User privacy is also at risk as different contract applications have different privacy standards.

Additionally, contract execution applications often collect more personal information from users than is needed to provide the application's functionality. This information may be misused by these applications for targeted advertising. The collection of users' attributes and preferences for contract purposes is a one-way flow. Platforms gather users' activity data and retain it permanently. Users have no control over their own activity data once it has been captured by the contract platform. Moreover, users do not use contract platforms with the intention of providing the platforms with their personal information beyond what is necessary for contract execution.

Furthermore, users' identities for contract purposes are stored on network servers. The server requires resources to host users' identities, keep them secure, and perform regular maintenance. Users do not always have control over their digital identity stored on the server for contract purposes. Every identity on the server does not necessarily correspond to a unique person, creating authentication challenges for contract execution. In the existing art, there is no known way to prevent the storage of duplicate or fraudulent identities for contract purposes. People need to manage credentials to access their own identities on the servers for contract signing.

To address some of the above issues and to manage credentials of a multitude of contract applications, Single Sign-On mechanisms such as OAUTH and SAML are used. The Single Sign-on mechanism allows contract applications to use tokens and transfer the burden of authentication to federated identity providers such as Google and Apple. During the handoff from third-party authentication to the contract client application, typically, personally identifiable information such as name, email, profile photo, etc., is also shared with the client application in an opt-out manner. This reintroduces vulnerabilities in the contract client application and negates the separation of identity authentication in the first place. Even if no personally identifiable information is handed off to the contract client application, the third-party authentication system is still susceptible to the same security challenges and all weaknesses are passed on downstream to contract execution processes.

Another technique adopted for contract security is two-factor authentication. There are several ways by which two-factor authentication can be enabled in order to provide an additional layer of security for contract signing. One method is by sending a code over email or text message. This assumes that the contract client application has access to the user's email or phone number which, if true, also means that they have the ability to determine the user's identity with relative ease. Additionally, if the user's phone or email are compromised, this system works in favor of the perpetrator and further injures the victim in contract-related fraud. Another method of two-factor authentication is enabled by generating a code via a separate authentication application. It assumes that the user has control over that authentication application. If the user loses access to the authenticator application, they lose access to their contract identity manager. Yet another method of two-factor authentication is enabled by having the user remember a pass-phrase, a visual shape, or answers that they made up for a number of personal questions, or any variant thereof. This usually results in an unreasonable barrier for the user and a bad user experience in contract execution.

Existing methods of affixing digital signatures for contract execution use, as a mechanism of authenticating the user's identity, the user's email, phone number, or merely the user's name hand-drawn by the user. Email and phone numbers are both external to the user and not permanently under the user's control for contract purposes. As for the hand-drawn name, it is not at all accurately reproducible, and has no original source against which it can be verified for contract authenticity. These traditional signature methods create significant vulnerabilities in contract enforceability and dispute resolution.

Current contract execution systems also lack immutable storage mechanisms. Documents are typically stored in conventional databases that can be altered, deleted, or corrupted over time. This creates challenges for long-term contract integrity and enforceability. There is no tamper-proof mechanism to ensure that executed contracts maintain their authenticity years after signing, leading to potential disputes about contract validity and terms.

Moreover, existing contract platforms fail to provide comprehensive end-to-end security that combines privacy-aware communication, unforgeable authentication, and permanent record-keeping in a single integrated solution. Current systems typically address only one aspect of the contract execution challenge-either secure communication, or biometric authentication, or document storage—but fail to provide a holistic approach that ensures privacy, authenticity, and permanence throughout the entire contract lifecycle.

Current digital contract execution systems suffer from several critical vulnerabilities that create a long-felt need for comprehensive solutions. Digital contract execution today is vulnerable to forgery, repudiation, identity spoofing, and poor auditability. Existing e-signature systems often rely on email addresses, phone numbers, or hand-drawn names, all of which can be forged or intercepted. Even with public-key infrastructures, digital signatures can be misused if credentials are stolen or shared. Conventional messaging networks also lack sufficient shared document privacy controls.

Thus, there is a long-felt need for:
A method of binding contracts directly to individual humans via biometric signing, eliminating the vulnerabilities associated with external identifiers that can be compromised.
Ensuring contracts remain biometrically bound, private, and encrypted throughout the entire execution process, from initial communication through final storage, thereby protecting sensitive contract information from interception or unauthorized access.
Recording executed contracts in tamper-proof blockchain ledgers that provide immutable, auditable records that cannot be altered or deleted, ensuring long-term contract integrity and enforceability.
Supporting group environments with complex permissioning rules for contract workflows, enabling enterprise-scale contract execution with role-based access controls and sequential signing capabilities for multiple parties.

Therefore, there is a long-standing need for an improved system and method for executing executing biometrically signed, cryptographically verifiable, blockchain-anchored contracts on a privacy-aware messaging platform, to overcome the above-mentioned problems while providing a comprehensive solution for secure digital contracting across multiple industries and use cases.

### SUMMARY

This summary is provided to introduce concepts related to a system and a method for executing biometrically signed, cryptographically verifiable, blockchain-anchored contracts on a privacy-aware messaging platform, and the concepts are further described below in the detailed description. This summary is not intended to identify essential features of the claimed subject matter nor is it intended for use in determining or limiting the scope of the claimed subject matter.

In one implementation of the present disclosure, a system for executing biometrically signed, cryptographically verifiable, blockchain-anchored contracts on a privacy-aware messaging platform is illustrated. The system further comprises a memory. The system further comprises a processor coupled with the memory wherein the processor is configured to execute programmed instructions stored in the memory. The programmed instructions further comprise a people registry module configured for registering a first user based on a user registration process. The programmed instructions further comprise a business registry module configured for registering a business entity by receiving and storing a business communication address associated with the business entity. The programmed instructions further comprise an account creation module configured for creating a business-customer account by generating a cryptographic key-value pair comprising a customer public key and a customer private key and creating a customer communication address for the first user and generating a business-customer communication address hash by applying a hashing algorithm to a combination of the business communication address and the customer communication address and generating a record in memory comprising the business-customer communication address hash and the customer public key. The programmed instructions further comprise a contract execution module configured for receiving a target document from the first user. The programmed instructions further comprise a biometric authentication module configured for affixing a first biometric signature to the target document by biometrically authenticating the first user and upon successful authentication affixing the first biometric signature. The programmed instructions further comprise a communication authentication module configured for transmitting the target document with the first biometric signature to a second user registered based on the user registration process wherein the target document is transmitted via an encrypted communication channel by extracting communication addresses from a communication request and generating a communication address hash using the hashing algorithm based on a combination of the communication addresses and comparing the communication address hash with the business-customer communication address hash from the record and upon matching encrypting the target document using the customer public key and transmitting the encrypted target document to the second user wherein the biometric authentication module is further configured for biometrically authenticating the second user upon receipt of the target document by the second user. The contract execution module is further configured for presenting the target document to the second user upon successful authentication and affixing to the target document a second biometric signature by the second user and transmitting a countersigned document comprising the first biometric signature and the second biometric signature back to the first user via the encrypted communication channel and storing a record of the countersigned document on a blockchain.

In another implementation of the present disclosure, a method of executing biometrically signed, cryptographically verifiable, blockchain-anchored contracts is illustrated. The method further comprises steps for registering a first user based on a user registration process. The method further comprises steps for registering a business entity by receiving and storing a business communication address associated with the business entity. The method further comprises steps for creating a business-customer account by generating a cryptographic key-value pair comprising a customer public key and a customer private key and creating a customer communication address for the first user and generating a business-customer communication address hash by applying a hashing algorithm to a combination of the business communication address and the customer communication address and generating a record in memory comprising the business-customer communication address hash and the customer public key. The method further comprises steps for receiving a target document from the first user. The method further comprises steps for affixing a first biometric signature to the target document by biometrically authenticating the first user and upon successful authentication affixing the first biometric signature. The method further comprises steps for transmitting the target document with the first biometric signature to a second user registered based on the user registration process wherein the target document is transmitted via an encrypted communication channel by extracting communication addresses from a communication request and generating a communication address hash using the hashing algorithm based on a combination of the communication addresses and comparing the communication address hash with the business-customer communication address hash from the record and upon matching encrypting the target document using the customer public key and transmitting the encrypted target document to the second user and biometrically authenticating the second user upon receipt of the target document by the second user. The method further comprises steps for presenting the target document to the second user upon successful authentication. The method further comprises steps for affixing to the target document a second biometric signature by the second user. The method further comprises steps for transmitting a countersigned document comprising the first biometric signature and the second biometric signature back to the first user via the encrypted communication channel. The method further comprises steps for storing a record of the countersigned document on a blockchain.

In yet another implementation of the present disclosure, a non-transitory computer-readable medium storing instructions that when executed by a processor perform the method of executing biometrically signed, cryptographically verifiable, blockchain-anchored contracts is illustrated. The instructions further comprise programmed code for registering a first user based on a user registration process. The instructions further comprise programmed code for registering a business entity by receiving and storing a business communication address associated with the business entity. The instructions further comprise programmed code for creating a business-customer account by generating a cryptographic key-value pair comprising a customer public key and a customer private key and creating a customer communication address for the first user and generating a business-customer communication address hash by applying a hashing algorithm to a combination of the business communication address and the customer communication address and generating a record in memory comprising the business-customer communication address hash and the customer public key. The instructions further comprise programmed code for receiving a target document from the first user. The instructions further comprise programmed code for affixing a first biometric signature to the target document by biometrically authenticating the first user and upon successful authentication affixing the first biometric signature. The instructions further comprise programmed code for transmitting the target document with the first biometric signature to a second user registered based on the user registration process wherein the target document is transmitted via an encrypted communication channel by extracting communication addresses from a communication request and generating a communication address hash using the hashing algorithm based on a combination of the communication addresses and comparing the communication address hash with the business-customer communication address hash from the record and upon matching encrypting the target document using the customer public key and transmitting the encrypted target document to the second user and biometrically authenticating the second user upon receipt of the target document by the second user. The instructions further comprise programmed code for presenting the target document to the second user upon successful authentication. The instructions further comprise programmed code for affixing to the target document a second biometric signature by the second user. The instructions further comprise programmed code for transmitting a countersigned document comprising the first biometric signature and the second biometric signature back to the first user via the encrypted communication channel. The instructions further comprise programmed code for storing a record of the countersigned document on a blockchain.

### BRIEF DESCRIPTION OF DRAWINGS

The detailed description is described with reference to the accompanying Figures. The same numbers are used throughout the drawings to refer to features and components.

FIG. 1 illustrates a network implementation of a system for executing biometrically signed, cryptographically verifiable, blockchain-anchored contracts on a privacy-aware messaging platform, in accordance with an embodiment of the present disclosure.

FIG. 2 illustrates components of the system for executing biometrically signed, cryptographically verifiable, blockchain-anchored contracts on a privacy-aware messaging platform, in accordance with an embodiment of the present disclosure.

FIG. 3 illustrates a method for executing biometrically signed, cryptographically verifiable, blockchain-anchored contracts on a privacy-aware messaging platform, in accordance with an embodiment of the present disclosure.

FIG. 4 illustrates a method for user registration based on biometric authentication data generation, in accordance with an embodiment of the present disclosure.

FIG. 5 illustrates a method for biometric authentication and affixing biometric signatures to target documents, in accordance with an embodiment of the present disclosure.

FIG. 6 illustrates a method for creating business-customer accounts with privacy-aware communication address hash generation, in accordance with an embodiment of the present disclosure.

FIG. 7 illustrates a method for transmitting target documents via encrypted communication channels with communication authentication, in accordance with an embodiment of the present disclosure.

FIG. 8 illustrates a method for storing records of countersigned documents on blockchain for permanent immutable storage, in accordance with an embodiment of the present disclosure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

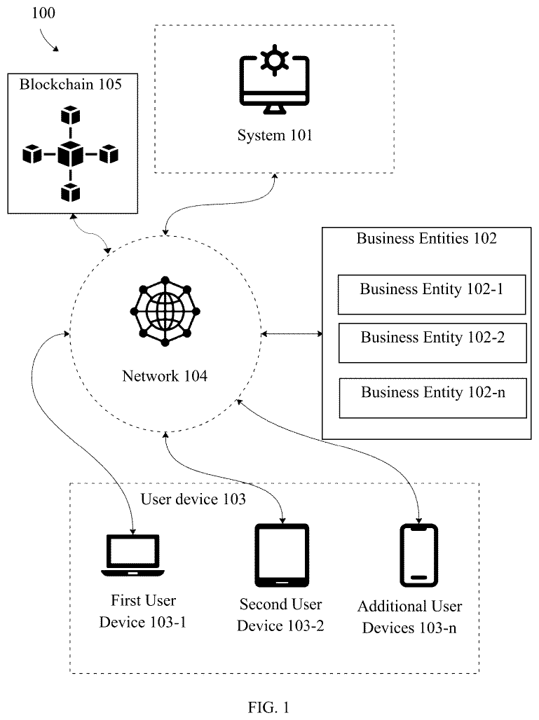

Referring to FIG. 1, a network implementation 100 of system 101 for executing biometrically signed, cryptographically verifiable, blockchain-anchored contracts, on a privacy-aware messaging platform is illustrated in accordance with an embodiment of the present subject matter. In one embodiment, the system 101 may correspond to a platform for enabling privacy-aware contract execution between one or more business entities 102 and one or more users, wherein the contract execution is secured through biometric authentication and recorded on a blockchain 105 for permanent immutable storage. The system 101 is communicatively coupled to user devices 103, business entities 102, communication network 104, and blockchain 105.

The privacy-aware messaging platform protects user privacy through several mechanisms working together. Proxy communication addresses hide users' actual email addresses and phone numbers from business entities. Hash-based authentication verifies that communications are legitimate without exposing the underlying addresses. Documents are encrypted with customer public keys so only intended recipients can decrypt them. Biometric authentication proves user identity without passwords that could be stolen. Permission controls prevent unauthorized parties from initiating communications even if they obtain proxy addresses. Together, these mechanisms ensure business entities never learn customers' actual contact information while maintaining secure communication for contract execution.

In one embodiment, the system 101 may be implemented using hardware, software, or a combination of both, which includes using where suitable, one or more computer programs, mobile applications, or other software applications deployed either on-premises over corresponding computing terminals or virtually over cloud infrastructure. The system 101 may include various micro-services or groups of independent computer programs which can act independently in collaboration with other micro-services. The system 101 may also interact with third-party or external computer systems. Internally, the system 101 may be the central processor of all requests for contract execution by the various actors or users of the system. A critical attribute of the system 101 is that it can complete contract execution transactions by users in collaboration with other systems.

In one embodiment, the system 101 is communicatively coupled to multiple users through one or more user devices 103-1, 103-2, 103-3 through 103-n, collectively referred to as user devices 103. The user devices 103 may be any electronic device, portable communication device such as a mobile telephone, that also contains other functions, such as PDA, a handheld device and/or music player functions, image capturing device, machine, a workstation, software, automated computer program, a robot, laptops, or tablet computers with touch-sensitive surfaces such as touch screen displays and/or touch pads. In one embodiment, the user devices 103 are enabled with biometric scanning capabilities. The biometric scanning capabilities may include facial recognition cameras, voice recognition systems, iris scanners, retina scanners, palm vein scanners, fingerprint scanners, or any other biometric identification technology. It should also be understood that, in some embodiments, the user device 103 is not a portable communications device, but is a desktop computer associated with a biometric scanning device.

In one embodiment, the business entities 102-1, 102-2, 102-3 through 102-n, collectively referred to as business entities 102, may comprise a set of online service providers, organizations, or individuals conducting business transactions. The business entities 102 may include but are not limited to financial institutions, healthcare providers, legal service providers, real estate agencies, e-commerce platforms, corporate entities, government agencies, or any other entity that requires execution of legally binding contracts with customers or other parties. Each business entity 102 is associated with at least one business communication address such as an email address or a phone number that is used for establishing secure communication channels with users through the system 101.

In one embodiment, the communication network 104 may be a cellular communication network, peer-to-peer network, internet-enabled network, or a virtual network. The communication network 104 facilitates encrypted communication between the system 101, user devices 103, and business entities 102. In another embodiment, the communication network 104 may support communication over one or more types of networks in accordance with the described embodiments. For example, the communication network 104 may support communications over a Wide Area Network (WAN), the Internet, cloud network, a telephone network such as analog, digital, POTS, PSTN, ISDN, xDSL, a mobile telephone network such as CDMA, GSM, NDAC, TDMA, E-TDMA, NAMPS, WCDMA, CDMA-2000, UMTS, 3G, 4G, 5G, 6G, a radio network, a television network, a cable network, an optical network such as PON, a satellite network such as VSAT, a packet-switched network, a circuit-switched network, a public network, a private network, and/or other wired or wireless communications network configured to carry data. The communication network 104 may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others.

In one embodiment, the communication network 104 is configured to support messaging group environments wherein multiple users can participate in contract review, negotiation, and execution processes. The communication network 104 may implement permissioning rules that define which users may view, comment on, endorse, recommend, edit, or sign target documents. The messaging group environment may support both sequential and non-sequential signing workflows, wherein contracts can be signed in a predetermined order or simultaneously by multiple parties. The communication network 104 further supports role-based permissions for multiple users, allowing different levels of access and authority within contract execution workflows.

In one embodiment, the blockchain 105 may be a distributed ledger technology that provides immutable storage for executed contract records. The blockchain 105 may be a public blockchain network such as Bitcoin, Ethereum, or Solana, or a private or permissioned blockchain network maintained by consortium members or specific organizations. The blockchain 105 receives transaction records from the system 101 and stores cryptographic hashes of countersigned documents along with associated metadata including signatory identifiers, timestamps, device identifiers, and other transaction parameters. The blockchain 105 ensures permanent immutable storage of contract records, preventing any alteration, deletion, or tampering with executed contracts. The blockchain 105 provides a tamper-proof audit trail that can be verified at any later time to confirm the validity and authenticity of executed contracts.

In one embodiment, the system 101 acts as an intermediary for contract execution between the business entities 102 and users operating through user devices 103. The system 101 may be configured to register users based on biometric authentication data without requiring disclosure of personally identifiable information. The system 101 may also be configured to register business entities 102 with verified business communication addresses. The system 101 creates business-customer accounts that establish secure, privacy-aware communication channels between business entities 102 and users. The system 101 coordinates the entire contract execution lifecycle from document receipt, through biometric signature affixation by multiple parties, to encrypted transmission, and finally to blockchain anchoring for permanent storage.

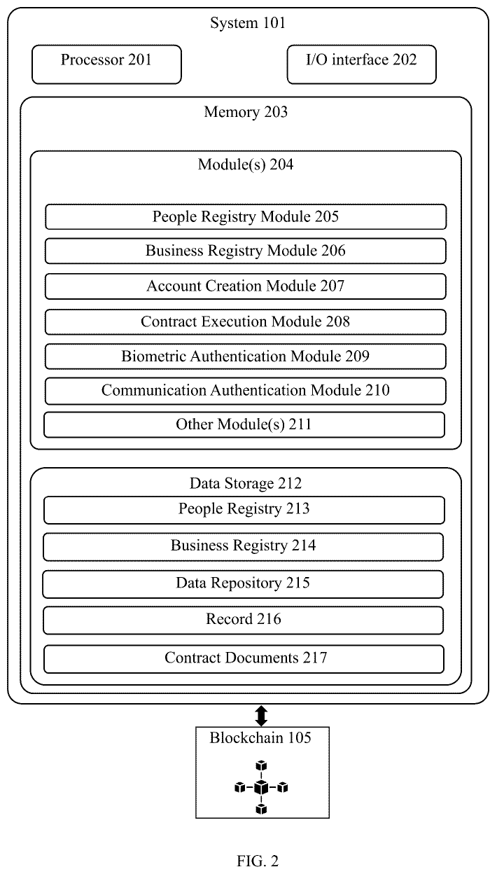

In an exemplary embodiment, a first user operating through a first user device 103-1 may register with the system 101 using biometric authentication. A business entity 102-1 may also register with the system 101 by providing a verified business communication address. When the first user wishes to engage in a contract with the business entity 102-1, the system 101 may create a business-customer account that generates cryptographic key-value pairs and establishes a privacy-aware communication channel using a combination of the business communication address and a customer communication address. The system 101 may then receive a target document from the first user, authenticates the first user biometrically, and affixes the first user's biometric signature to the target document. The system 101 may then transmit the signed document to a second user operating through a second user device 103-2 via the encrypted communication network 104, using communication address hash authentication to ensure only authorized parties can access the document. Upon receipt, the system 101 biometrically authenticates the second user, may present the document for review, and affixes the second user's biometric signature upon approval. The countersigned document is transmitted back to the first user via the encrypted communication network 104, and the system 101 stores a record of the executed contract on the blockchain 105 for permanent immutable storage. This entire process ensures privacy, authenticity, and permanence throughout the contract execution lifecycle. The system for executing cryptographically verifiable contracts is further illustrated with the block diagram in FIG. 2.

Referring now to FIG. 2, various components of the system 101 are illustrated, in accordance with an embodiment of the present subject matter. As shown, the system 101 may include at least one processor 201, an input/output interface 202, and a memory 203. The memory 203 consists of a set of modules 204 and data storage 212. The set of modules 204 may include a people registry module 205, a business registry module 206, an account creation module 207, a contract execution module 208, a biometric authentication module 209, and a communication authentication module 210. In one embodiment, the processor 201 is configured to fetch and execute computer-readable programmed instructions stored in the memory 203 corresponding to each module. In an embodiment, the programmed instructions may include routines, programs, objects, components, data structures, etc., which perform particular tasks, functions, or implement particular abstract data types.

In one embodiment, the processor 201 may comprise a standard microprocessor, microcontroller, central processing unit (CPU), distributed or cloud processing unit, state machines, logic circuitries, and/or any devices that manipulate signals based on operational instructions and/or other processing logic that accommodates the requirements of the present invention. The processor 201 is responsible for executing all programmed instructions stored in the memory 203 and coordinating the operations of all modules 204 to achieve the objectives of executing biometrically signed, cryptographically verifiable, blockchain-anchored contracts, on the privacy-aware messaging platform.

Further, the input/output (I/O) interface 202 is an interface to other components of the system 101. The I/O interface 202 may include a variety of software and hardware interfaces, for example, a web interface, a graphical user interface, and the like. The I/O interface 202 may allow the system 101 to interact with users directly through the user devices 103 or indirectly through external systems. Further, the I/O interface 202 may enable the system 101 to communicate with other computing devices, such as web servers, external data servers, business entity systems, and blockchain networks. The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting a number of devices to one another or to another server. In one embodiment, the I/O interface 202 allows the system 101 to be logically coupled to user devices 103, business entity systems 102, communication network 104, and blockchain 105. Illustrative components that may communicate through I/O interface 202 include tablets, mobile phones, biometric scanners, document management systems, blockchain nodes, and messaging servers.

In one embodiment, the memory 203 may include any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, Solid State Disks (SSD), optical disks, magnetic tapes, memory cards, virtual memory and distributed cloud storage. The memory 203 may be removable, non-removable, or a combination thereof. The memory 203 may include routines, programs, objects, components, data structures, etc., which perform particular tasks or implement particular abstract data types. The memory 203 may include programs or coded instructions that supplement applications and functions of the system 101. In one embodiment, the memory 203, amongst other things, serves as a repository for storing data processed, received, and generated by one or more of the programs or the coded instructions. In yet another embodiment, the memory 203 may be managed under a federated structure that enables adaptability and responsiveness of the system 101.

In an embodiment of the present subject matter, the people registry module 205 may comprise a set of computer programmed instructions for registering a first user or a second user with the system 101 based on a user registration process. The user registration process enables users to register without disclosing personally identifiable information such as email addresses, phone numbers, or names, thereby protecting user privacy while ensuring authentic identity verification through biometric authentication.

In one exemplary embodiment, the steps for the user registration process corresponding to the first user or the second user comprises receiving a first set of biometric samples of the first user or the second user corresponding to one or more biometric factors. The one or more biometric factors may correspond to face, voice, retina, iris, fingerprint, and palm vein, or any combination thereof. For example, a user named Alice may use her smartphone equipped with a facial recognition camera and a fingerprint scanner to register with the system 101. The people registry module 205 receives biometric samples from Alice's face scan captured by the user device 103. These biometric samples are captured through the biometric scanning capabilities of the user device 103 and transmitted to the system 101 via the I/O interface 202.

The people registry module 205 is configured to process the first set of biometric samples to compute a first Secret-Key (S1) corresponding to the first user or the second user. The processing of biometric samples involves analyzing unique characteristics and features present in the biometric data. For facial samples, this may include facial landmarks, distances between features, and unique facial geometry. For voice samples, this may include voice frequency patterns, pitch, tone, and speech characteristics. For fingerprint samples, this may include ridge patterns, minutiae points, and bifurcations. The people registry module 205 applies biometric feature extraction algorithms to identify and extract these unique characteristics from the biometric samples. The extracted features are then processed through cryptographic algorithms to compute the first Secret-Key (S1). Continuing the example, Alice's facial geometry features are extracted and cryptographically processed to generate her unique Secret-Key (S1). It must be noted that the first Secret-Key (S1) is computationally derived from the biometric samples and represents a cryptographic representation of the user's biometric identity. The first Secret-Key (S1) is not stored permanently in the system 101 or on the user device 103, thereby ensuring that biometric data cannot be compromised or stolen.

The people registry module 205 is further configured to generate a first Unique-Number (N1) using a random number generation algorithm. The random number generation algorithm may be any cryptographically secure random number generator known in the art, such as a pseudorandom number generator (PRNG), cryptographically secure pseudorandom number generator (CSPRNG), or hardware-based random number generator. The first Unique-Number (N1) is generated only once during the user registration process and serves as a permanent identifier associated with the user's biometric identity. For example, the system 101 generates a unique number “N1=847392047583920475” for Alice during her registration process. This unique number is randomly generated and has no correlation to any personally identifiable information about Alice.

The people registry module 205 is further configured to apply a cryptographic Function (F1) to the first Secret-Key (S1) and the first Unique-Number (N1) to compute a first Public-Key (P1). The cryptographic Function (F1) may be based on Asymmetric Key Encryption techniques such as RSA (Rivest-Shamir-Adleman), ECC (Elliptic Curve Cryptography), Diffie-Hellman key exchange, or any other public-key cryptographic system. The cryptographic Function (F1) takes as inputs both the first Secret-Key (S1) derived from biometric data and the first Unique-Number (N1) generated randomly, and produces as output the first Public-Key (P1). The mathematical relationship can be expressed as P1=F1 (S1, N1). For example, for Alice, the system computes P1=F1 (Alice's Secret-Key S1, Alice's Unique-Number N1=847392047583920475), resulting in Alice's unique Public-Key P1. The first Public-Key (P1) serves as a publicly accessible identifier that can be used for authentication and verification purposes without revealing the underlying biometric data or the Secret-Key.

The people registry module 205 is further configured to store the first Unique-Number (N1) on a user device of the first user or the second user and in a data repository 215. Storing the first Unique-Number (N1) in two locations provides redundancy and ensures that the user can be authenticated even if one storage location becomes unavailable. On the user device 103, the first Unique-Number (N1) may be stored in secure storage such as a secure enclave, trusted execution environment (TEE), or encrypted storage partition. For example, Alice's Unique-Number (N1=847392047583920475) is stored in the secure enclave of her iPhone and simultaneously stored in the data repository 215 of the system 101. The data repository 215, which is part of the data storage 212, maintains a secure database of Unique-Numbers associated with registered users, indexed by user identifiers or biometric hashes to enable efficient retrieval during authentication processes.

The people registry module 205 is further configured to store the first Public-Key (P1) on a storage device. The storage device may be the data storage 212 within the system 101, or may be a separate storage system accessible by the system 101. The first Public-Key (P1) is stored in a manner that allows it to be retrieved during subsequent authentication processes. For example, Alice's Public-Key (P1) is stored in the data storage 212 and can be retrieved by the system 101 whenever Alice needs to be authenticated or whenever Alice needs to affix her biometric signature to a document. The storage of the first Public-Key (P1) enables the system 101 to verify the authenticity of users during real-time authentication without requiring storage of sensitive biometric data or Secret-Keys.

Upon completion of the user registration process, the people registry module 205 generates a registration record that is stored in the people registry 213, which is part of the data storage 212. The people registry 213 maintains records of all registered users, including references to their stored Unique-Numbers (N1), Public-Keys (P1), and associated metadata such as registration timestamps and device identifiers. In the example, Alice's registration record is created in the people registry 213, establishing her as a verified user of the system 101 without requiring her to disclose any personally identifiable information such as her email address, phone number, or name.

It must be understood that the user registration process described above applies equally to the first user and the second user, and indeed to any number of users who wish to register with the system 101. Each user undergoes the same biometric-based registration process, ensuring consistency and security across all user registrations. The beauty of this approach is that it creates unforgeable user identities tied directly to biometric characteristics that cannot be shared, stolen, or replicated, while simultaneously protecting user privacy by avoiding the collection of traditional personally identifiable information.

In an embodiment of the present subject matter, the business registry module 206 may comprise a set of computer programmed instructions for registering a business entity with the system 101. The registration of business entities ensures that only legitimate, verified organizations can participate in contract execution processes on the platform, thereby preventing fraudulent business activities.

The business registry module 206 is configured to receive and store a business communication address associated with the business entity. The business communication address comprises an email address or a phone number that is officially associated with the business entity. For example, a real estate company named “SecureDeals Real Estate Agency” may register with the system 101 using their official business email address “contracts@securedeals.com” or their business phone number “+1-555-CONTRACT”. The business registry module 206 receives the business communication address from the business entity through the I/O interface 202.

In one embodiment, the business registry module 206 is further configured to perform verification of the business communication address to ensure authenticity. The verification process may include validating email domain ownership, verifying phone number ownership through SMS verification codes, checking business registration databases, validating business licenses, or conducting identity verification of business representatives. For example, when SecureDeals Real Estate Agency submits their email address “contracts@securedeals.com”, the business registry module 206 may send a verification email to that address requiring the business to click a verification link or enter a verification code. The business registry module 206 may also verify that the domain “securedeals.com” is registered to a legitimate business entity by checking domain registration records and SSL certificates.

Once verified, the business registry module 206 stores the business communication address in the business registry 214, which is part of the data storage 212. The business registry 214 maintains a database of all registered business entities along with their verified business communication addresses and associated metadata such as business names, registration dates, verification status, and business identifiers. In the example, SecureDeals Real Estate Agency's record is created in the business registry 214 with their verified email address “contracts@securedeals.com” and associated business information.

The business registry module 206 may also store additional information about the business entity, such as business type, industry category, geographic location, business size, and regulatory compliance information. This additional information may be used by the system 101 to apply appropriate permissioning rules, compliance requirements, and industry-specific workflows during contract execution processes.

In an embodiment of the present subject matter, the account creation module 207 may comprise a set of computer programmed instructions for creating a business-customer account. The business-customer account represents a secure, privacy-aware relationship between a business entity registered in the business registry 214 and a user (customer) registered in the people registry 213. The creation of a business-customer account establishes an exclusive communication channel through which contract-related communications can occur with authentication and encryption.

The account creation module 207 is configured to create a business-customer account through a series of coordinated steps that establish cryptographic security and privacy protection. The creation of the business-customer account is typically initiated when a registered user wishes to engage in business transactions or contract execution with a registered business entity.

In an alternate embodiment, the account creation module 207 is configured to generate a cryptographic key-value pair comprising a customer public key and a customer private key. The cryptographic key-value pair is generated using asymmetric encryption algorithms such as RSA, ECC, or other public-key cryptography methods. The customer public key is used for encrypting communications sent to the customer, while the customer private key is used by the customer to decrypt received communications. For example, when Alice (the first user) wishes to engage with SecureDeals Real Estate Agency to execute a house purchase contract, the account creation module 207 generates a cryptographic key-value pair specifically for this business-customer relationship. The system generates Alice's customer public key (PubKey_Alice_SecureDeals) and customer private key (PrivKey_Alice_SecureDeals) for this specific business-customer account. The customer private key is securely transmitted to Alice's user device 103 through an encrypted channel, while the customer public key is stored in the system 101 for use in encrypting communications sent to Alice.

In an embodiment, it must be noted that the system 101 uses two separate cryptographic key systems that serve different purposes. The first system uses biometric keys including Secret-Keys (S1) and (S2), Public-Key (P1), and Unique-Numbers (N1) and (N2) as described in user registration. These keys verify who the person is and enable unforgeable biometric signatures. The second system uses the customer public key and customer private key generated when creating a business-customer account. These keys encrypt and decrypt documents during transmission. The term cryptographic key-value pair refers to this second system where the public key encrypts and the private key decrypts. A user has one set of biometric keys proving their identity for all transactions, but multiple customer key pairs with one unique pair for each business relationship. If one business relationship's keys are compromised, other business communications remain secure.

The customer private key may be transmitted to the user's device using secure transport protocols such as TLS and stored in protected areas like secure enclaves or trusted execution environments. When a document arrives encrypted, the user's device retrieves the customer private key from secure storage, decrypts the document, and displays it to the user without exposing the private key itself.

In an alternate embodiment, the system 101 may use a unified cryptographic key system wherein the biometric authentication keys also serve the document encryption and decryption functions. In this embodiment, the Public-Key (P1) generated during user registration serves dual purposes as both the authentication key and the customer public key for encrypting communications. The Unique-Number (N1) stored on the user device 103 serves as the basis for document decryption. When the system 101 creates a business-customer account in this alternate embodiment, instead of generating a new cryptographic key-value pair, the account creation module 207 retrieves the user's existing Public-Key (P1) from the people registry 213 and designates it as the customer public key for encrypting documents sent to that user. When the user needs to decrypt a received document, the user device 103 retrieves the stored Unique-Number (N1) and combines it with the Secret-Key (S2) generated from a real-time biometric sample to derive the decryption capability using the inverse of cryptographic Function (F1), thereby decrypting the document through the same biometric authentication infrastructure used for signature affixation. This unified approach eliminates the need to generate and manage separate encryption keys for each business-customer relationship, simplifies key lifecycle management, and ensures that document encryption and user authentication are cryptographically bound to the same biometric identity, though it provides less cryptographic isolation between different business relationships compared to the two-system approach described earlier.

The account creation module 207 is further configured to create a customer communication address for the first user. The customer communication address comprises a proxy email address or a proxy phone number that serves as an intermediary identifier for communications between the business entity and the customer. The proxy nature of the customer communication address ensures that the customer's actual personal email address or phone number is never revealed to the business entity, thereby protecting the customer's privacy. For example, the account creation module 207 creates a proxy email address for Alice such as “customer_8473920@securedeals-contracts.com” or a proxy phone number such as “+1-555-PROXY-847”. This proxy address is unique to the relationship between Alice and SecureDeals Real Estate Agency and is used exclusively for communications related to contracts between these two parties. Alice's actual personal email address or phone number remains hidden from SecureDeals, and SecureDeals cannot use this proxy address to contact Alice outside the context of their business relationship on the platform.

The account creation module 207 is further configured to generate a business-customer communication address hash by applying a hashing algorithm to a combination of the business communication address and the customer communication address. The hashing algorithm corresponds to a one-way hash function such as SHA-256, SHA-512, MD5, or any other cryptographically secure hashing algorithm. A one-way hash function is a mathematical function that takes an input and produces a fixed-size output (hash) in such a way that it is computationally infeasible to reverse the process and derive the original input from the hash output.

The generation of the business-customer communication address hash proceeds as follows: The account creation module 207 retrieves the business communication address (for example, “contracts@securedeals.com”) from the business registry 214 and combines it with the newly created customer communication address (for example, “customer_8473920@securedeals-contracts.com”). The combination may be performed by concatenating the two addresses may be a single string “contracts@securedeals.com|customer_8473920@securedeals-contracts.com”. The account creation module 207 may then apply the hashing algorithm to this combined string to produce the business-customer communication address hash. For example, applying SHA-256 hashing to the combined string produces a hash value such as “a7b9c4d3e5f8g1h2i6j9k3l7m2n8o4p1q5r9s3t7u2v6w1x5y9z4”. This hash value uniquely represents the relationship between SecureDeals Real Estate Agency and Alice, and serves as an authentication token for all communications between these parties.

The account creation module 207 is further configured to generate a record in memory comprising the business-customer communication address hash and the customer public key. This record, referred to as record 216, is stored in the data storage 212. The record 216 establishes the authenticated relationship between the business entity and the customer and contains the essential information needed to validate communications and encrypt data for this specific business-customer relationship. For example, the record 216 for the Alice-SecureDeals relationship contains: (1) the business-customer communication address hash “a7b9c4d3e5f8g1h2i6j9k3l7m2n8o4p1q5r9s3t7u2v6w1x5y9z4”, and (2) Alice's customer public key “PubKey_Alice_SecureDeals”. This record 216 is indexed in the data storage 212 and can be quickly retrieved whenever communications occur between SecureDeals and Alice.

In some embodiments, the record 216 may also include additional information such as account creation timestamp, expiration date (if applicable), permission settings, customer preferences, and transaction history references. For example, the record 216 may include a customer promotion preference flag that indicates whether Alice wishes to receive promotional communications from SecureDeals in addition to transactional communications related to contract execution. This preference flag may be set to “YES” or “NO” based on Alice's choice during account creation or through subsequent preference management.

Upon completion of the account creation process, the business-customer account is established and ready for secure, privacy-aware contract execution. The business entity (SecureDeals) can now send contract-related communications to the customer (Alice) through the proxy communication address, and the system 101 will authenticate these communications using the business-customer communication address hash and encrypt them using the customer public key before delivery to Alice. Conversely, Alice can send communications to SecureDeals through the system 101, which will authenticate and route these communications appropriately. Throughout this entire process, Alice's personal contact information remains completely hidden from SecureDeals, and the integrity of all communications is protected by cryptographic authentication and encryption.

In an embodiment of the present subject matter, the contract execution module 208 may comprise a set of computer programmed instructions for coordinating the overall contract execution workflow, including receiving target documents, managing the signature affixation process, coordinating document transmission between parties, and storing executed contracts.

The contract execution module 208 is configured for receiving a target document from the first user. The target document may be any contractual agreement, legal document, terms and conditions, purchase agreement, employment contract, non-disclosure agreement, lease agreement, or any other document requiring signatures from one or more parties. The target document may be uploaded by the first user through the user device 103, may be generated by a business entity and presented to the first user for signature, or may be created collaboratively through the system 101. For example, Alice (the first user) may upload a house purchase offer document for a property she wishes to buy from a seller represented by SecureDeals Real Estate Agency. Alternatively, SecureDeals may generate a standard house purchase agreement template and present it to Alice for review and signature. The contract execution module 208 receives the target document through the I/O interface 202 and stores it temporarily in the contract documents 217, which is part of the data storage 212.

In one embodiment, the contract execution module 208 is further configured to process document signing requests generated upon scanning a machine-readable code. The machine-readable code may be a QR code, barcode, NFC tag, or any other machine-readable identifier that encodes information about the target document and signing requirements. For example, SecureDeals may present Alice with a QR code displayed on a web page showing the house purchase agreement. When Alice scans this QR code using her user device 103 equipped with a camera and QR code scanning capability, the contract execution module 208 receives a document signing request that includes information such as: the document identifier, the business entity identifier (SecureDeals), the customer identifier (derived from Alice's biometric hash), and any special instructions or permissions related to the signing process. This QR code-based approach provides a seamless and secure method for initiating document signing workflows, especially in scenarios where documents are displayed on large screens or printed materials.

The contract execution module 208 is further configured to coordinate the overall signature workflow, which may involve sequential or non-sequential signing by multiple parties. In sequential signing workflows, the document must be signed by parties in a predetermined order. For example, Alice may need to sign the house purchase offer first, then the seller must sign to accept the offer, then a real estate attorney must sign to validate the terms, and finally a notary must sign to officially record the transaction. The contract execution module 208 enforces this signing sequence and prevents out-of-order signatures. In non-sequential signing workflows, multiple parties can sign simultaneously without any required order. For example, in a multi-party business partnership agreement, all partners may sign concurrently without waiting for others to sign first.

The contract execution module 208 is further configured to operate within messaging group environments with complex permissioning rules. A messaging group environment is a collaborative space where multiple users can view, discuss, edit, and sign documents with different levels of access and permissions. The permissioning rules define which users may view, comment on, endorse, recommend, edit, or sign the target document. For example, in a corporate contract scenario, the messaging group environment might include: (1) junior employees who can view and comment on the contract but cannot edit or sign, (2) managers who can view, comment, and endorse the contract, (3) legal counsel who can view, comment, recommend changes, and edit the contract, (4) executives who can view and sign the contract, and (5) the CEO who must provide final signature approval. The contract execution module 208 enforces these permissioning rules by checking each user's role and permissions before allowing any action on the target document.

The contract execution module 208 is further configured to support role-based permissions for multiple users. Role-based permissions assign different capabilities to users based on their roles within the organization or transaction. The contract execution module 208 maintains a permission matrix that maps each user role to their allowed actions and enforces these permissions throughout the contract execution workflow. For example, in the SecureDeals and Alice house purchase scenario, the roles might be defined as:
(1) Buyer (Alice)—can view, edit offer terms, and sign the purchase offer
(2) Seller (Bob)—can view, accept or reject offer terms, and sign acceptance
(3) Real Estate Agent (SecureDeals representative)—can view, facilitate negotiations, but cannot sign the contract
(4) Escrow Officer—can view, manage funds, and sign escrow documents
(5) Title Company—can view ownership records and sign title transfer documents.

The contract execution module 208 is further configured to present the target document to the second user upon successful authentication. After the first user (Alice) has signed the target document and it has been transmitted to the second user (for example, Bob the seller), the contract execution module 208 retrieves the document from contract documents 217, verifies that the second user (Bob) has been successfully authenticated by the biometric authentication module 209, and then presents the document to Bob through Bob's user device 103. The presentation may include displaying the document contents, highlighting the sections that require Bob's review and signature, showing Alice's signature already affixed to the document, and providing an interface for Bob to approve or reject the document.

The contract execution module 208 is further configured to coordinate affixation of a second biometric signature to the target document by the second user. After presenting the document to the second user (Bob) and receiving Bob's approval to sign, the contract execution module 208 works in coordination with the biometric authentication module 209 to capture Bob's biometric authentication and affix Bob's biometric signature to the document. This process will be described in detail below in the description of the biometric authentication module 209.

The contract execution module 208 is further configured to coordinate transmission of a countersigned document comprising the first biometric signature and the second biometric signature back to the first user via the encrypted communication channel. Once both Alice and Bob have affixed their biometric signatures to the house purchase agreement, the document becomes a countersigned document representing a binding contract between the parties. The contract execution module 208 packages the countersigned document along with signature metadata (timestamps, authentication records, device identifiers) and coordinates with the communication authentication module 210 to transmit the countersigned document back to Alice via the encrypted communication channel. Alice receives the fully executed contract on her user device 103, where she can view both her signature and Bob's signature along with the complete terms of the agreement.

The contract execution module 208 is further configured to store a record of the countersigned document on a blockchain. This blockchain storage functionality will be described in detail below in the description of blockchain storage processes. The contract execution module 208 ensures that every fully executed contract is permanently recorded on the blockchain 105, creating an immutable audit trail that can be verified at any future time.

In an embodiment of the present subject matter, the biometric authentication module 209 may comprise a set of computer programmed instructions for performing real-time biometric authentication of users and affixing biometric signatures to target documents upon successful authentication. The biometric authentication module 209 is configured for affixing a first biometric signature to the target document by biometrically authenticating the first user and, upon successful authentication, affixing the first biometric signature. The process of affixing a biometric signature comprises multiple coordinated steps that ensure the signature is truly from the claimed user and cannot be forged or repudiated.

The biometric authentication module 209 first receives a real-time biometric sample captured from the first user or the second user. When a user wishes to sign a document, the biometric authentication module 209 prompts the user through their user device 103 to provide a biometric sample. For example, when Alice wishes to sign the house purchase agreement, the biometric authentication module 209 sends a request to Alice's smartphone prompting her to place her finger on the fingerprint scanner or to position her face in front of the camera for facial recognition. Alice complies by scanning her face, and the real-time biometric sample is captured by the camera on her user device 103. This real-time biometric sample is then transmitted to the system 101 via the I/O interface 202 through an encrypted communication channel to prevent interception or tampering.

The biometric authentication module 209 then processes the real-time biometric sample to generate a second Secret-Key (S2). The processing of the real-time biometric sample follows the same feature extraction and cryptographic processing algorithms that were used during the initial user registration process. The biometric authentication module 209 analyzes Alice's real-time face scan to extract unique features such as ridge patterns, minutiae points, and bifurcations. These extracted features are then cryptographically processed to generate the second Secret-Key (S2). It is critical to note that if the real-time biometric sample is truly from Alice, the second Secret-Key (S2) generated from the real-time sample will match the first Secret-Key (S1) that was generated during Alice's original registration process. However, the first Secret-Key (S1) was never stored anywhere in the system, so the comparison cannot be made directly on the Secret-Keys themselves. Instead, the comparison is made using the Unique-Numbers derived from these Secret-Keys, as described in the following steps.

The biometric authentication module 209 then fetches the first Public-Key (P1) from the storage device. The storage device, which is part of the data storage 212, contains the first Public-Key (P1) that was generated and stored during the user registration process. The biometric authentication module 209 retrieves Alice's first Public-Key (P1) that was stored when Alice initially registered with the system 101. This retrieval is performed by querying the data storage 212 using Alice's user identifier or biometric hash as a search key.

The biometric authentication module 209 then computes a Real-Time-Unique-Number (N2) using the first Public-Key (P1), the second Secret-Key (S2), and the cryptographic Function (F1). This computation represents the reverse operation of the cryptographic Function that was used during registration. During registration, the relationship was P1=F1 (S1, N1). During authentication, the biometric authentication module 209 uses the inverse relationship to compute N2=F1_inverse (P1, S2), where F1_inverse represents the inverse operation of the cryptographic Function F1. For Alice's authentication, the system computes the Real-Time-Unique-Number N2 using Alice's stored Public-Key (P1), the newly generated Secret-Key (S2) from her real-time biometric sample, and the inverse of the cryptographic Function F1.

The biometric authentication module 209 then authenticates the first user or the second user based on comparison of the Real-Time-Unique-Number (N2) with the first Unique-Number (N1). The first Unique-Number (N1) was stored on the user device 103 and in the data repository 215 during the registration process. The biometric authentication module 209 retrieves the first Unique-Number (N1) from either the user device 103 or from the data repository 215 and compares it with the Real-Time-Unique-Number (N2) that was just computed. If Alice's real-time biometric sample is authentic (truly from Alice), then the second Secret-Key (S2) will equal the first Secret-Key (S1), which means the Real-Time-Unique-Number (N2) will equal the first Unique-Number (N1). The biometric authentication module 209 performs a comparison: if N2 equals N1, authentication succeeds; if N2 does not equal N1, authentication fails. For example, if Alice's stored Unique-Number is N1=847392047583920475 and the Real-Time-Unique-Number computed from her current face scan is N2=847392047583920475, the numbers match exactly and Alice is successfully authenticated. However, if an imposter tries to forge Alice's signature by using their own face or a fake face, the Real-Time-Unique-Number computed from the fraudulent biometric sample will not match Alice's stored Unique-Number, and authentication will fail, preventing the forgery.

Upon successful authentication, the biometric authentication module 209 affixes the first biometric signature or the second biometric signature to the target document. In one embodiment, the first biometric signature and the second biometric signature are each derived from a one-way hash of the respective biometric data combined with a unique nonce generated at the time of signing. A nonce (number used once) is a random or pseudo-random number that is generated specifically for a single use and ensures that each signature is unique even if the same user signs multiple documents. The biometric authentication module 209 generates a unique nonce at the moment Alice approves signing the document, for example nonce=“n847583920b4c7d9e2f5”. The biometric authentication module 209 then combines Alice's biometric data (or a hash thereof) with this nonce and applies a one-way hash function to generate the biometric signature. For example, the biometric signature might be computed as: Signature_Alice=Hash (Alice's_Biometric_Hash+nonce+Document_Hash+Timestamp). This signature is then embedded into the target document as metadata, creating a permanent record that Alice signed this specific document at a specific time using her verified biometric identity. The signature cannot be copied to another document because it includes the document hash as part of its computation, and it cannot be reused because it includes a unique nonce and timestamp.

The biometric authentication module 209 is further configured to perform re-authentication of at least one of the first user or the second user at a later time to verify the countersigned document. This re-authentication capability addresses scenarios where the validity or authenticity of a contract is questioned months or years after its execution. For example, three years after Alice and Bob signed the house purchase agreement, there may be a legal dispute about whether Bob actually signed the contract. The biometric authentication module 209 can perform re-authentication by requesting Bob to provide verification biometric samples. Bob scans his face using his current user device 103, and the biometric authentication module 209 processes these verification biometric samples to regenerate authentication data using the same process described above (generate Secret-Key, compute Real-Time-Unique-Number, compare with stored Unique-Number). The biometric authentication module 209 then compares the regenerated authentication data with stored authentication data that was recorded at the time of the original contract signing. If the regenerated authentication data matches the stored authentication data, this confirms that the signature was indeed affixed by Bob and confirms the validity of the countersigned document. This re-authentication capability provides powerful legal protection against contract repudiation, as it allows parties to cryptographically prove their signatures years after the fact using their unchanging biometric characteristics.

The biometric authentication module 209 is further configured to biometrically authenticate the second user upon receipt of the target document by the second user. After the first user (Alice) signs the target document and it is transmitted to the second user (Bob), the biometric authentication module 209 performs the same real-time biometric authentication process for Bob before allowing him to view or sign the document. This ensures that only the intended recipient (Bob) can access the document, preventing unauthorized viewing or signing by imposters or unauthorized parties. The authentication process for the second user follows exactly the same steps as described above for the first user: receiving real-time biometric sample, processing to generate Secret-Key, fetching Public-Key, computing Real-Time-Unique-Number, comparing with stored Unique-Number, and affixing biometric signature upon successful authentication.

In an embodiment of the present subject matter, the communication authentication module 210 may comprise a set of computer programmed instructions for authenticating communications between parties and ensuring that documents are transmitted only through verified, encrypted channels to authorized recipients. The communication authentication module 210 is configured for transmitting the target document with the first biometric signature to a second user registered based on the user registration process. The transmission occurs via an encrypted communication channel that ensures end-to-end confidentiality and integrity of the document during transit. The encrypted communication channel may utilize encryption protocols such as TLS (Transport Layer Security), AES (Advanced Encryption Standard), or other strong encryption methods to protect the document from interception, eavesdropping, or tampering during transmission over the communication network 104.

The communication authentication module 210 performs the transmission through a series of coordinated authentication and encryption steps. The communication authentication module 210 first extracts communication addresses from a communication request. When the first user (Alice) signs a document and requests that it be transmitted to the second user (Bob), a communication request is generated that includes addressing information for both the sender and recipient. The communication authentication module 210 extracts from this communication request: (1) a first communication address associated with the business entity (for example, “contracts@securedeals.com” for SecureDeals Real Estate Agency acting as intermediary), and (2) a second communication address associated with the customer (for example, “customer_8473920@securedeals-contracts.com” which is Alice's proxy address). These extracted addresses represent the communication endpoints for this specific transmission.

In an embodiment, the communication request may be a data structure that starts document transmission between users. It contains the sender's communication address, the recipient's communication address, the target document itself or a reference to it, and transmission settings like priority and confirmation requirements. The communication authentication module extracts the addresses from this request, generates a hash from combining them, compares this hash with stored hashes to verify the communication is authorized, and then encrypts and transmits the document if authentication succeeds.

The communication authentication module 210 then generates a communication address hash using the hashing algorithm based on a combination of the communication addresses. The communication authentication module 210 combines the first communication address and the second communication address (for example, by concatenating them: “contracts@securedeals.com|customer_8473920@securedeals-contracts.com”) and applies the same hashing algorithm that was used during account creation (such as SHA-256) to generate a communication address hash. For example, the communication address hash might be computed as “a7b9c4d3e5f8g1h2i6j9k3l7m2n8o4p1q5r9s3t7u2v6w1x5y9z4”.

The communication authentication module 210 then compares the communication address hash with the business-customer communication address hash from the record. The communication authentication module 210 retrieves the record 216 from the data storage 212 that was created during the business-customer account creation process. This record 216 contains the business-customer communication address hash that was generated when Alice's account with SecureDeals was first established. The communication authentication module 210 performs a direct comparison between the newly generated communication address hash and the stored business-customer communication address hash. If the two hashes match exactly, this proves that the communication is occurring between the exact business entity and customer who established this account, no unauthorized party is attempting to intercept or redirect the communication, and the communication addresses have not been spoofed or tampered with.

Upon matching of the communication address hashes, the communication authentication module 210 encrypts the target document using the customer public key. The customer public key was stored in the record 216 during account creation and is retrieved by the communication authentication module 210 for encryption purposes. The communication authentication module 210 uses asymmetric encryption with the customer public key to encrypt the target document (which now includes Alice's biometric signature). For example, the target document containing the house purchase agreement and Alice's signature is encrypted using Alice's customer public key “PubKey_Alice_SecureDeals”, producing an encrypted version of the document that can only be decrypted using Alice's corresponding customer private key. This encryption ensures that even if the encrypted document is intercepted during transmission over the communication network 104, the interceptor cannot read the contents of the document because they do not possess the customer private key required for decryption.

The communication authentication module 210 then transmits the encrypted target document to the second user. The encrypted target document is transmitted via the communication network 104 to the user device 103 of the second user (Bob). The transmission may occur through various communication channels such as email, SMS, instant messaging, or direct network communication, depending on the configuration of the communication network 104. When Bob's user device 103 receives the encrypted target document, the document can be decrypted using Bob's customer private key (which was securely transmitted to Bob's device during account creation), allowing Bob to view the document contents and Alice's signature. The communication authentication module 210 may also notify Bob through multiple channels that a new document requiring his review and signature has been received, ensuring that Bob is aware of the pending contract that requires his attention.

In one embodiment, the communication authentication module 210 is further configured to block all subsequent communication attempts if the communication address hash does not match with the business-customer communication address hash. This blocking functionality provides critical security protection against spoofing, phishing, and unauthorized access attempts. If an attacker attempts to send a fraudulent document to Alice by spoofing the business communication address or customer communication address, the communication authentication module 210 will generate a communication address hash based on the attacker's spoofed addresses. This fraudulent communication address hash will not match the legitimate business-customer communication address hash stored in the record 216, because the hash functions are extremely sensitive to even tiny changes in input data. The communication authentication module 210 detects this hash mismatch and immediately blocks the communication attempt, preventing the fraudulent document from reaching Alice. Additionally, the communication authentication module 210 may log the blocked attempt in the data storage 212 for security monitoring and may alert system administrators about potential security threats. For example, if an attacker tries to send Alice a fake house purchase agreement claiming to be from SecureDeals but using a slightly different email address like “contract@securedeals.com” (missing the ‘s’ in ‘contracts’), the communication address hash generated from this spoofed address will not match the stored hash, and the attack will be blocked before Alice ever sees the fraudulent document.

The communication authentication module 210 may also enforce time-based restrictions on communications, such as expiring communication channels after a certain period, requiring re-authentication for communications after inactivity periods, or enforcing business hours for communication delivery. These additional security measures further protect users from unauthorized communications and enhance the overall security of the contract execution platform.

The other modules 211 may include various utility modules, administrative modules, reporting modules, compliance modules, integration modules, and support functions that enhance the overall operation of the system 101 but are not directly part of the core contract execution workflow.

Further, the memory 203 comprises data storage 212. The data storage 212 serves as a repository for storing data processed, received, and generated by one or more of the modules 204 and other modules 211. The data storage 212 may be implemented as a centralized storage system where all data is stored in a single database or data center, or as a distributed storage system where data is distributed across multiple storage nodes, geographic locations, or cloud storage services to provide redundancy, scalability, and fault tolerance. In a distributed storage configuration, the data storage 212 may utilize technologies such as distributed databases, replicated storage, sharding, or blockchain-based storage to ensure data availability and integrity even if individual storage nodes fail or become unavailable.

The data storage 212 comprises several specialized data repositories and databases, each serving specific purposes within the contract execution system. The data storage 212 comprises the people registry 213. The people registry 213 stores information related to registered users who have completed the user registration process through the people registry module 205. The people registry 213 maintains records that include references to users' biometric authentication data, including stored Public-Keys (P1), references to Unique-Numbers (N1) stored on user devices and in the data repository 215, registration timestamps, device identifiers used during registration, and anonymized user identifiers that do not reveal personally identifiable information. The people registry 213 does not store actual biometric samples or Secret-Keys, thereby protecting users' biometric privacy even if the people registry 213 is compromised. The people registry 213 may be indexed by anonymized biometric hashes to enable efficient retrieval of user records during authentication processes. For example, when Alice registers with the system 101, a record is created in the people registry 213 that includes a reference to her Public-Key (P1), a reference to her Unique-Number (N1) storage locations, her registration timestamp, and an anonymized identifier, but does not include her name, email, phone number, or actual biometric data.

The business registry 214 stores information related to registered business entities that have completed registration through the business registry module 206. The business registry 214 maintains records that include verified business communication addresses (email addresses and/or phone numbers), business names, business identifiers, business types and industry categories, registration dates and verification dates, verification status indicators, business licenses and registration numbers, contact information for business representatives, and compliance certifications. The business registry 214 enables the system 101 to verify the legitimacy of business entities participating in contract execution and to enforce business-specific policies and permissions. For example, when SecureDeals Real Estate Agency registers with the system 101, a record is created in the business registry 214 that includes their verified email address “contracts@securedeals.com”, business name “SecureDeals Real Estate Agency”, business type “Real Estate Services”, registration date, verification status “Verified”, real estate license number, and contact information for their legal department.

The data repository 215 serves as one of the storage locations for Unique-Numbers (N1) generated during user registration processes. As described in the people registry module 205, each user's Unique-Number (N1) is stored in two locations: on the user device 103 and in the data repository 215. The data repository 215 maintains a secure database of these Unique-Numbers indexed by user identifiers or biometric hashes. The redundant storage of Unique-Numbers in the data repository 215 ensures that users can still be authenticated even if they lose access to their original user device 103 or if the user device 103 is damaged or replaced. The data repository 215 may implement additional security measures such as encryption at rest, access control lists, audit logging, and secure key management to protect the stored Unique-Numbers from unauthorized access or tampering. For example, Alice's Unique-Number “N1=847392047583920475” is stored in the data repository 215 with encryption and access controls that allow only the biometric authentication module 209 to retrieve it during authentication processes.

The record 216 stores information related to business-customer accounts created through the account creation module 207. Each business-customer relationship has a corresponding record 216 that contains the business-customer communication address hash and the customer public key. The record 216 serves as the authentication and encryption reference for all communications between a specific business entity and customer pair. For example, the record 216 for the relationship between SecureDeals Real Estate Agency and Alice contains: (1) the business-customer communication address hash “a7b9c4d3e5f8g1h2i6j9k3l7m2n8o4p1q5r9s3t7u2v6w1x5y9z4” that uniquely identifies this relationship and serves as an authentication token for communications, and (2) Alice's customer public key “PubKey_Alice_SecureDeals” that is used to encrypt communications sent to Alice in this business relationship.

The record 216 may also include additional information such as account creation timestamp indicating when the business-customer relationship was established, customer promotion preference flags indicating whether the customer has opted to receive promotional communications from this business entity, permission settings defining what types of communications are allowed, contract history references pointing to contracts that have been executed between these parties, and expiration dates or renewal dates if the business-customer relationship has time-based limitations.

The record 216 enables the communication authentication module 210 to quickly authenticate communication attempts and retrieve the appropriate encryption keys for securing communications. The record 216 is indexed by business identifier and customer identifier to enable efficient retrieval during communication processing. Multiple records 216 may exist for a single customer if that customer has relationships with multiple business entities, and similarly multiple records 216 may exist for a single business entity if that business has relationships with multiple customers.

The contract documents 217 repository stores target documents received from users, documents in various stages of the signing process, and fully executed countersigned documents. The contract documents 217 maintains the actual content of contracts including all text, images, embedded data, formatting, and metadata. Each document stored in contract documents 217 may include the document content in various formats (PDF, Word, HTML, plain text), document metadata including document identifier, creation timestamp, last modified timestamp, and version number, signature records indicating which parties have signed the document, including their biometric signatures, signature timestamps, and authentication records, document status indicators showing whether the document is draft, pending signatures, partially signed, fully executed, or archived, references to associated records 216 identifying the business-customer relationships involved in the contract, and blockchain references linking to the permanent blockchain record of executed contracts.

Further, the system 101 is communicatively coupled to blockchain 105, as illustrated in both FIG. 1 and FIG. 2. The blockchain 105 provides the permanent immutable storage layer for executed contract records. When a contract has been fully executed with all required signatures affixed, the system 101 stores a record of the countersigned document on the blockchain 105 through a process coordinated by the contract execution module 208.

The process of storing the record on the blockchain comprises several steps. First, the system 101 generates a cryptographic hash of the countersigned document. The cryptographic hash is generated by applying a cryptographic hashing algorithm such as SHA-256, SHA-512, or Keccak (used in Ethereum) to the complete contents of the countersigned document. The cryptographic hash produces a fixed-size unique fingerprint of the document that serves as a tamper-evident seal. For example, when Alice and Bob's house purchase agreement is fully signed, the system 101 computes a cryptographic hash of the entire document: Hash (Document_Content+Alice's_Signature+Bob's_Signature)=“7f9a8b2c3d4e5f6a1b2c3d4e5f6a7b8c9d0e1f2a3b4c5d6e7f8a9b0c1d2e3f4a”. Any alteration to the document, even changing a single character or punctuation mark, would produce a completely different hash value, making tampering immediately detectable.

Second, the system 101 generates transaction metadata comprising signatory identifiers, timestamps, device identifiers, and other transaction parameters. The transaction metadata provides contextual information about the contract execution that supplements the document hash. The signatory identifiers include anonymized references to the users who signed the document (derived from their biometric hashes, not personally identifiable information). The timestamps record the exact date and time each signature was affixed, using precision time sources and potentially time-stamping services to ensure accuracy and legal validity. The device identifiers record the hardware identifiers of the user devices 103 used for signing, providing additional verification of the signing events. Other transaction parameters may include geographic locations where signatures were affixed (if location services are enabled and users consent), IP addresses of user devices (if network-level logging is enabled), session identifiers linking to detailed authentication logs, and contract type categorization for reporting and compliance purposes.

Third, the system 101 generates a transaction record comprising the cryptographic hash and the transaction metadata. The transaction record packages together all the information that will be permanently stored on the blockchain 105. For example, the transaction record for Alice and Bob's contract might be structured as:

{“document_hash″:
″7f9a8b2c3d4e5f6a1b2c3d4e5f6a7b8c9d0e1f2a3b4c5d6e7f8a9b0c1d2e3f4a″,
″signatory_1″: ″biometric_hash_Alice_847392047583920475″,
″signature_1_timestamp″: ″2025-09-30T14:32:18Z″,
″signature_1_device″: ″iPhone_15_IMEI_358924051234567″,
″signatory_2″: ″biometric_hash_Bob_293847563029384756″,
″signature_2_timestamp″: ″2025-09-30T16:45:52Z″,
″signature_2_device″: ″Samsung_Galaxy_IMEI_865432109876543″,
″contract_type″: ″Real_Estate_Purchase″,
″system_reference″: ″SYS_101_CONTRACT_20250930_001847″}

Fourth, the system 101 writes the transaction record on a blockchain for permanent immutable storage. The writing process involves submitting the transaction record to the blockchain network 105 through blockchain API calls or node connections. If the blockchain 105 is a public blockchain like Ethereum, the system 101 may create a smart contract transaction or data transaction that includes the transaction record in the transaction data field. If the blockchain 105 is a private or permissioned blockchain, the system 101 submits the transaction to authorized validator nodes that will include it in the next block. Once the transaction is included in a block and the block is confirmed by the network consensus mechanism (such as proof-of-work, proof-of-stake, or Byzantine fault tolerance), the transaction record becomes permanently part of the blockchain's immutable ledger. The blockchain 105 provides cryptographic guarantees that the stored record cannot be altered, deleted, or tampered with, because any such tampering would require recomputing all subsequent blocks in the blockchain, which is computationally infeasible in properly designed blockchain systems.

The system 101 receives from the blockchain 105 a transaction identifier (also called transaction hash or transaction ID) that uniquely identifies the location of the stored record within the blockchain. For example, the blockchain 105 might return a transaction identifier: “TX_0x4f8b9c3a2d1e5f6a7b8c9d0e1f2a3b4c5d6e7f8a9b0c1d2e3f4a5b6c7d8e9f0”. This transaction identifier is stored by the system 101 in the contract documents 217 as a reference that links the executed contract to its permanent blockchain record. At any future time, anyone can use this transaction identifier to query the blockchain 105 and retrieve the stored transaction record, verifying the contract's authenticity, the signatures that were affixed, and the timestamps of the signing events.

The blockchain storage provides several critical benefits for contract execution. First, it provides immutability—once stored on the blockchain 105, the contract record cannot be altered or deleted, ensuring permanent preservation of evidence. Second, it provides transparency—the blockchain record can be independently verified by anyone with access to the blockchain, not just by the system 101, ensuring that the system operator cannot manipulate or hide contract records. Third, it provides decentralization—the blockchain 105 is maintained by multiple nodes in a distributed network, ensuring that contract records survive even if the system 101 or individual blockchain nodes fail or are compromised. Fourth, it provides trustlessness—parties do not need to trust the system 101 or each other, because the mathematical and cryptographic properties of the blockchain 105 guarantee the integrity of stored records independently of any trusted authority.

In one embodiment, the system 101 may support multiple blockchain networks, allowing users or business entities to choose which blockchain 105 to use for storing their contract records based on factors such as transaction costs, confirmation speed, privacy features, or regulatory requirements. For example, high-value real estate contracts might be stored on the Bitcoin blockchain for maximum security and immutability, while routine business contracts might be stored on a private Ethereum-based blockchain for cost efficiency and privacy. The system 101 may also implement blockchain interoperability features that allow contract records to be verified across multiple blockchains simultaneously, providing additional redundancy and verification capabilities.

In another embodiment, the system 101 may implement distributed messaging network capabilities, wherein every user action within the network is biometrically authenticated, cryptographically signed, and recorded on a blockchain. This extends the blockchain storage concept beyond just executed contracts to include the entire workflow of contract creation, negotiation, review, and execution. For example, when Alice uploads the initial house purchase offer document, that action is biometrically authenticated and recorded on the blockchain 105. When the document is transmitted to Bob, that transmission event is cryptographically signed and recorded on the blockchain 105. When Bob reviews the document and proposes a counteroffer, that action is biometrically authenticated and recorded on the blockchain 105. When both parties finally sign, those signature events are recorded on the blockchain 105 as described above. This comprehensive blockchain logging creates a complete, immutable audit trail of the entire contract lifecycle that can be used for dispute resolution, compliance audits, process analysis, and legal evidence.

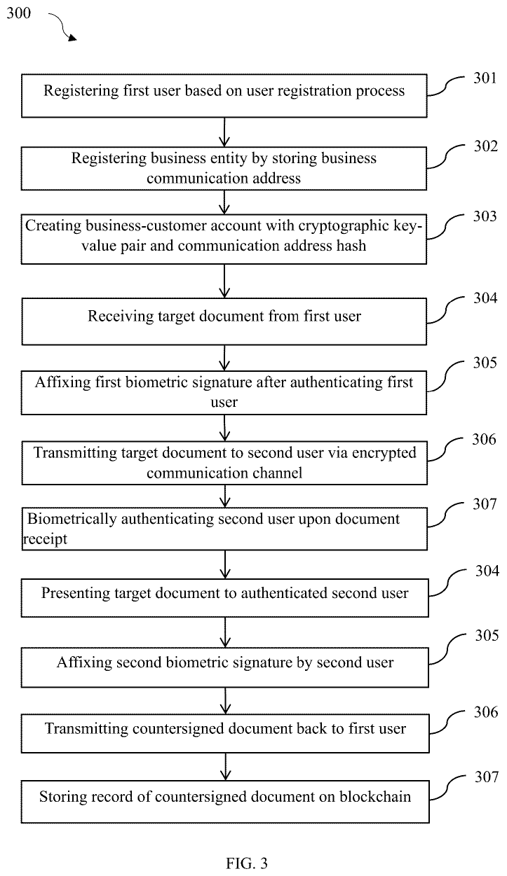

Now referring to FIG. 3, a method 300 for executing biometrically signed, cryptographically verifiable, blockchain-anchored contracts on a privacy-aware messaging platform is illustrated, in accordance with an embodiment of the present subject matter. The method 300 comprises a series of processor-implemented steps that enable secure contract execution between multiple parties while protecting user privacy through anonymized biometric authentication and ensuring permanent immutability through blockchain storage.

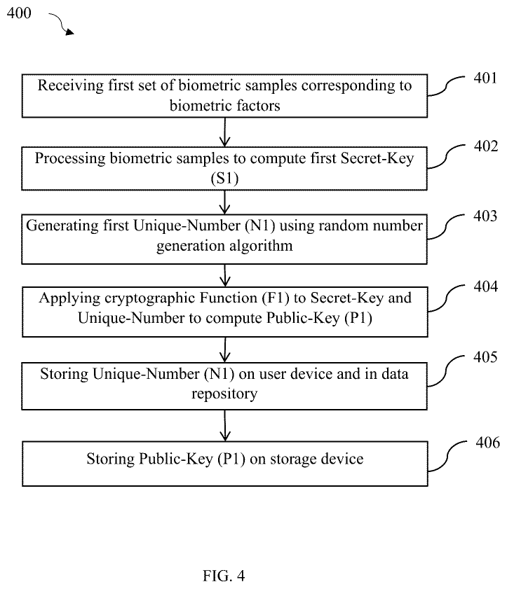

At step 301, the processor 201 registers a first user based on a user registration process. The user registration process enables users to register without disclosing personally identifiable information such as email addresses, phone numbers, or names. The processor 201 executes programmed instructions of the people registry module 205 to receive biometric samples from the first user corresponding to one or more biometric factors such as face, voice, retina, iris, fingerprint, and palm vein. The processor 201 processes these biometric samples to generate authentication data that uniquely identifies the first user based on their biometric characteristics. The detailed steps for user registration with biometric authentication data generation are further elaborated with reference to FIG. 4.

At step 302, the processor 201 registers a business entity by receiving and storing a business communication address associated with the business entity. The business communication address comprises an email address or a phone number that is officially associated with the business entity. The processor 201 executes programmed instructions of the business registry module 206 to receive and verify the business communication address through mechanisms such as validating email domain ownership, verifying phone number ownership through SMS verification codes, or checking business registration databases. Once verified, the processor 201 stores the business communication address in the business registry 214 along with associated metadata such as business names, registration dates, verification status, and business identifiers.

At step 303, the processor 201 creates a business-customer account through coordinated sub-steps that establish cryptographic security and privacy protection for communications between the business entity and customer. The processor 201 executes programmed instructions of the account creation module 207 to generate a cryptographic key-value pair comprising a customer public key and a customer private key using asymmetric encryption algorithms such as RSA, ECC, or other public-key cryptography methods. The customer public key is used for encrypting communications sent to the customer, while the customer private key is used by the customer to decrypt received communications. The customer private key is securely transmitted to the customer's user device 103 through an encrypted channel and stored in secure storage such as a secure enclave or trusted execution environment, while the customer public key is retained by the system 101.

The processor 201 creates a customer communication address for the first user comprising a proxy email address or proxy phone number that serves as an intermediary identifier. The proxy nature ensures that the customer's actual personal email address or phone number is never revealed to the business entity, thereby protecting customer privacy. The processor 201 generates the proxy address using strategies such as random string generation combined with a system-controlled domain, virtual phone number allocation, hash-based generation, or sequential allocation from available pools.

The processor 201 generates a business-customer communication address hash by applying a hashing algorithm to a combination of the business communication address and the customer communication address. The hashing algorithm corresponds to a one-way hash function such as SHA-256, SHA-512, MD5, or any other cryptographically secure hashing algorithm. The processor 201 retrieves the business communication address from the business registry 214, combines it with the newly created customer communication address through concatenation using a consistent format, and applies the hashing algorithm to produce a unique hash value that represents the relationship between this specific business entity and customer.

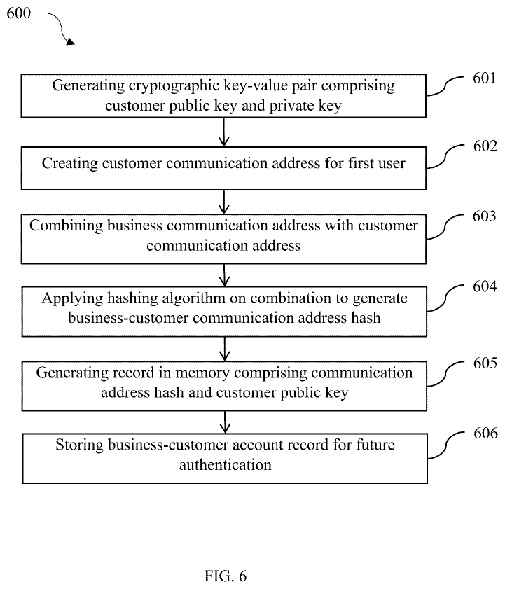

The processor 201 generates a record in memory (record 216) comprising the business-customer communication address hash and the customer public key. This record establishes the authenticated relationship and contains the essential information needed to validate communications and encrypt data for this specific business-customer relationship. The record 216 may also include additional information such as account creation timestamp, customer promotion preferences, permission settings, and transaction history references. The detailed steps for creating business-customer accounts with privacy-aware communication address hash generation are further elaborated with reference to FIG. 6.

At step 304, the processor 201 receives a target document from the first user. The target document may be any contractual agreement, legal document, purchase agreement, employment contract, non-disclosure agreement, lease agreement, or any other document requiring signatures from one or more parties. The processor 201 executes programmed instructions of the contract execution module 208 to receive the target document through the I/O interface 202 and stores it in the contract documents 217. In one embodiment, receiving the target document comprises receiving a document signing request generated upon scanning a machine-readable code such as a QR code, barcode, or NFC tag that encodes information about the target document and signing requirements.

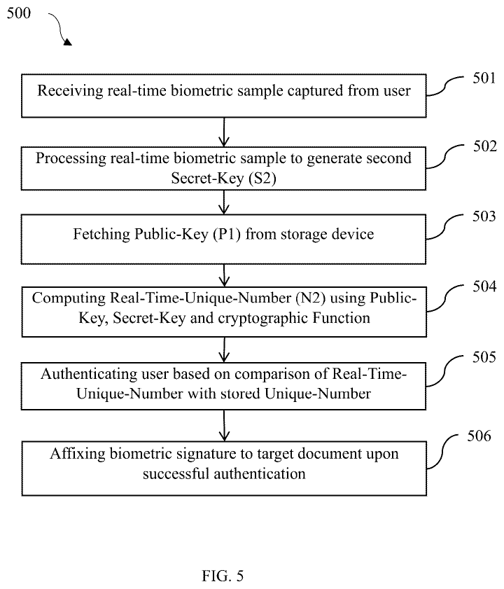

At step 305, the processor 201 affixes a first biometric signature to the target document by biometrically authenticating the first user and, upon successful authentication, affixing the first biometric signature. The processor 201 executes programmed instructions of the biometric authentication module 209 to perform real-time biometric authentication. The processor 201 prompts the first user through their user device 103 to provide a biometric sample, receives the real-time biometric sample, and processes it to generate authentication data. The processor 201 compares this authentication data with stored authentication data that was recorded during the user's initial registration process. If authentication succeeds, the processor 201 affixes the first biometric signature to the target document. In one embodiment, the first biometric signature is derived from a one-way hash of the biometric data combined with a unique nonce generated at the time of signing, ensuring each signature is unique, time-bound, and document-specific. The processor 201 generates a unique nonce, combines it with the user's biometric data and the document hash, and applies a one-way hash function to create the biometric signature that is embedded into the target document as metadata. The detailed steps for biometric authentication and affixing biometric signatures are further elaborated with reference to FIG. 5.

At step 306, the processor 201 transmits the target document with the first biometric signature to a second user registered based on the user registration process, via an encrypted communication channel. The processor 201 executes programmed instructions of the communication authentication module 210 to perform transmission through coordinated authentication and encryption steps. The processor 201 extracts communication addresses from a communication request, including a first communication address associated with the business entity and a second communication address associated with the customer. The processor 201 generates a communication address hash using the same hashing algorithm based on a combination of the extracted communication addresses. The processor 201 compares the communication address hash with the business-customer communication address hash from the record 216. If the two hashes match exactly, this proves that the communication is occurring between the exact business entity and customer who established this account, and that no unauthorized party is attempting to intercept or redirect the communication.

Upon matching of the communication address hashes, the processor 201 encrypts the target document using the customer public key retrieved from the record 216. The processor 201 applies asymmetric encryption, which may use a hybrid encryption approach where a random symmetric encryption key encrypts the document content and the symmetric key itself is encrypted using the customer public key. The processor 201 transmits the encrypted target document to the second user via the communication network 104 to the user device 103 of the second user through channels such as email, SMS, instant messaging, or application-based transmission. In one embodiment, the processor 201 blocks all subsequent communication attempts if the communication address hash does not match with the business-customer communication address hash from the record, logging the blocked attempt in security logs and potentially alerting affected parties about the unauthorized communication attempt.

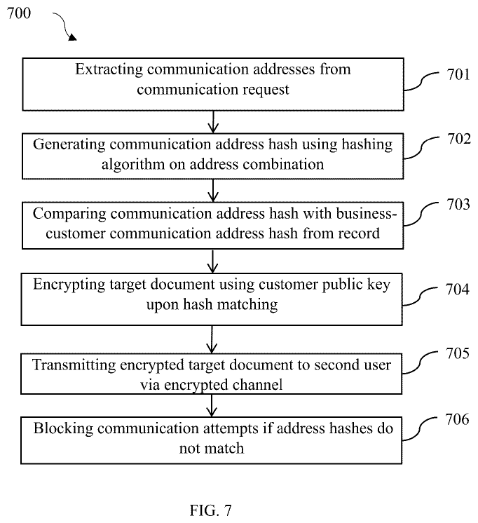

Further at step 306, the processor 201 biometrically authenticates the second user upon receipt of the target document. When the second user's device receives the encrypted target document, the processor 201 executes programmed instructions of the biometric authentication module 209 to perform real-time biometric authentication of the second user before allowing access to view or sign the document. The processor 201 prompts the second user to provide a biometric sample, processes it to generate authentication data, and compares with stored authentication data from the second user's initial registration. The detailed steps for transmitting target documents via encrypted communication channels with communication authentication are further elaborated with reference to FIG. 7.

At step 307, the processor 201 presents the target document to the second user upon successful authentication. After the second user is successfully authenticated through biometric verification, the processor 201 executes programmed instructions of the contract execution module 208 to retrieve the target document from contract documents 217, decrypt it using appropriate decryption keys, and transmit it to the second user's device for display. The presentation may occur within a messaging group environment configured with permissioning rules that define which users may view, comment on, endorse, recommend, edit, or sign the target document. The messaging group environment supports sequential and non-sequential signing workflows, wherein contracts can be signed in a predetermined order or simultaneously by multiple parties. The messaging group environment further supports role-based permissions for multiple users, allowing different levels of access and authority within contract execution workflows based on organizational roles or transaction requirements.

At step 308, the processor 201 affixes to the target document a second biometric signature by the second user. After the second user reviews the target document and approves signing, the processor 201 executes programmed instructions of the biometric authentication module 209 to perform real-time biometric authentication for signature affixation. The processor 201 prompts the second user to provide a biometric sample for signing purposes, processes it to generate authentication data, and compares with stored authentication data to verify the second user's identity. Upon successful authentication, the processor 201 affixes the second biometric signature to the target document. Similar to the first biometric signature, the second biometric signature is derived from a one-way hash of the second user's biometric data combined with a unique nonce generated at the time of signing. The processor 201 embeds the second biometric signature into the document as metadata, creating a permanent record of the second user's signature. The document now contains both the first biometric signature and the second biometric signature, making it a countersigned document representing a binding contract between the parties.

At step 309, the processor 201 transmits a countersigned document comprising the first biometric signature and the second biometric signature back to the first user via the encrypted communication channel. Once both users have affixed their biometric signatures to the document, the processor 201 executes programmed instructions of the communication authentication module 210 to package the countersigned document along with signature metadata including timestamps, authentication records, and device identifiers. The processor 201 encrypts the countersigned document using the first user's customer public key and transmits it via the communication network 104 to the first user's device, where it can be decrypted using the first user's customer private key. The processor 201 may send notifications through multiple channels informing the first user that the contract has been fully executed and is available for review.

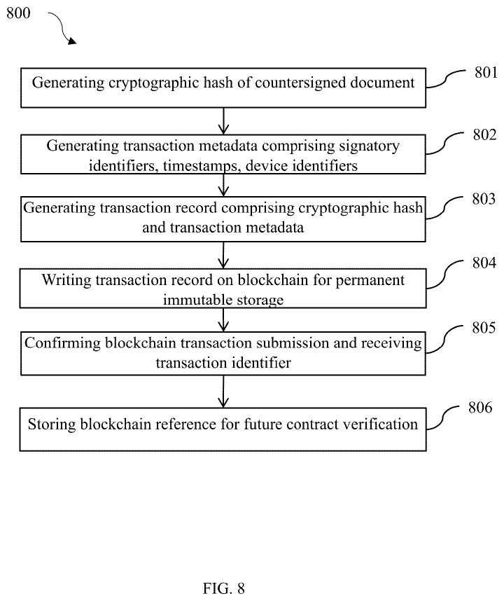

At step 310, the processor 201 stores a record of the countersigned document on a blockchain. The processor 201 executes programmed instructions of the contract execution module 208 to coordinate the blockchain storage process, which provides permanent immutable storage of executed contract records. The detailed steps for storing records of countersigned documents on blockchain for permanent immutable storage are further elaborated with reference to FIG. 8.

In one embodiment, the processor 201 may be further configured to perform re-authentication of at least one of the first user or the second user at a later time to verify the countersigned document. This re-authentication capability addresses scenarios where the validity or authenticity of a contract is questioned months or years after its execution. The processor 201 receives verification biometric samples from the user, processes these verification biometric samples to regenerate authentication data using the same process used during original authentication, and compares the regenerated authentication data with stored authentication data that was recorded at the time of the original contract signing. If the regenerated authentication data matches the stored authentication data, this confirms that the signature was indeed affixed by that user and confirms the validity of the countersigned document, providing powerful legal protection against contract repudiation.

In another embodiment, the method 300 may be performed across a distributed messaging network, wherein every user action within the network is biometrically authenticated, cryptographically signed, and recorded on a blockchain. This comprehensive approach creates a complete, immutable audit trail of the entire contract lifecycle from initial document creation through final execution, providing enhanced security, auditability, and dispute resolution capabilities. The method 300 provides a comprehensive workflow for executing cryptographically verifiable contracts that combines privacy-aware communication through business-customer address hashing with biometric authentication for unforgeable signatures and blockchain storage for permanent immutability.

Now referring to FIG. 4, a method 400 for user registration with biometric authentication data generation is illustrated, in accordance with an embodiment of the present subject matter. The method 400 corresponds to the user registration process referenced in step 301 of FIG. 3 and provides detailed steps for registering users with the system 101 based on biometric authentication without requiring disclosure of personally identifiable information.

At step 401, the processor 201 receives a first set of biometric samples of the first user or the second user corresponding to one or more biometric factors. The one or more biometric factors correspond to face, voice, retina, iris, fingerprint, and palm vein, or any combination thereof. The processor 201 executes programmed instructions of the people registry module 205 to receive biometric samples from users through their user devices 103 equipped with biometric scanning capabilities such as facial recognition cameras, fingerprint scanners, voice recognition microphones, iris scanners, retina scanners, or palm vein scanners. The user device 103 captures these biometric samples and transmits them to the system 101 via the I/O interface 202 through an encrypted communication channel to prevent interception during transmission. The first set of biometric samples may include multiple samples of the same biometric factor or samples of different biometric factors to increase authentication accuracy and provide redundancy.

At step 402, the processor 201 processes the first set of biometric samples to compute a first Secret-Key (S1) corresponding to the first user or the second user. The processing involves applying biometric feature extraction algorithms to analyze unique characteristics present in each biometric sample. For fingerprint samples, the processor 201 identifies and extracts ridge patterns, minutiae points (ridge endings and bifurcations), ridge counts, and core and delta positions. For facial samples, the processor 201 identifies facial landmarks such as eye positions, nose tip, mouth corners, and jawline contours, and computes distances and angles between these landmarks. For voice samples, the processor 201 analyzes voice frequency patterns, pitch variations, tone characteristics, and phonetic features. For iris samples, the processor 201 analyzes iris texture patterns, collarette structure, and crypts. For retina samples, the processor 201 analyzes blood vessel patterns. For palm vein samples, the processor 201 analyzes the unique pattern of veins using near-infrared imaging.

After extracting these biometric features, the processor 201 normalizes and standardizes the features to account for variations in capture conditions such as lighting, angle, distance, and sensor quality. The processor 201 then applies cryptographic processing to the extracted and normalized features to compute the first Secret-Key (S1) through cryptographic hash functions, fuzzy extractors, secure sketches, or other cryptographic primitives that transform biometric features into a cryptographic key. The first Secret-Key (S1) is a cryptographic representation of the user's biometric identity that can be reproducibly generated from biometric samples but cannot be reverse-engineered to reconstruct the original biometric images. Importantly, the first Secret-Key (S1) is computed in real-time during registration and is not stored permanently anywhere in the system 101 or on the user device 103, thereby ensuring that even if the system is compromised, attackers cannot obtain users' Secret-Keys.

At step 403, the processor 201 generates a first Unique-Number (N1) using a random number generation algorithm. The random number generation algorithm may be any cryptographically secure random number generator such as a pseudorandom number generator (PRNG) seeded with high-entropy sources, a cryptographically secure pseudorandom number generator (CSPRNG) such as/dev/urandom in Unix systems or CryptGenRandom in Windows systems, or a hardware-based random number generator that uses physical processes such as electronic noise or quantum phenomena. The processor 201 executes the random number generation algorithm to produce a unique number with sufficient length and randomness to ensure uniqueness across all users of the system 101. The first Unique-Number (N1) has no correlation to any personally identifiable information about the user, no correlation to biometric characteristics, and is statistically guaranteed to be unique among all users. The first Unique-Number (N1) is generated only once during the user registration process and serves as a permanent identifier associated with the user's biometric identity throughout their use of the system 101.

At step 404, the processor 201 applies a cryptographic Function (F1) to the first Secret-Key (S1) and the first Unique-Number (N1) to compute a first Public-Key (P1). The cryptographic Function (F1) may be based on asymmetric key encryption techniques that use mathematical relationships between public and private keys, implementing algorithms such as RSA (Rivest-Shamir-Adleman) involving modular exponentiation with large prime numbers, ECC (Elliptic Curve Cryptography) involving point multiplication on elliptic curves, Diffie-Hellman key exchange involving discrete logarithm problems, ElGamal encryption involving multiplicative groups of integers modulo a prime, or other public-key cryptographic systems based on mathematical problems that are computationally difficult to solve.

The processor 201 takes as inputs both the first Secret-Key (S1) derived from the user's biometric data and the first Unique-Number (N1) generated randomly, and applies the cryptographic Function (F1) to produce as output the first Public-Key (P1), expressed mathematically as P1=F1 (S1, N1). The first Public-Key (P1) has several important properties: it is mathematically related to both the Secret-Key (S1) and the Unique-Number (N1), it can be publicly shared without revealing the Secret-Key (S1) or enabling unauthorized authentication, it can be used to verify authentication attempts by users, and it serves as a publicly accessible identifier for cryptographic operations without revealing sensitive biometric data. The cryptographic Function (F1) is designed such that it is computationally easy to compute the Public-Key from the Secret-Key and Unique-Number, but computationally infeasible to reverse the process and derive the Secret-Key from the Public-Key and Unique-Number, ensuring the security of the user's biometric identity.

At step 405, the processor 201 stores the first Unique-Number (N1) on a user device of the first user or the second user and in a data repository. Storing the first Unique-Number (N1) in two separate locations provides redundancy and ensures that the user can be authenticated even if one storage location becomes unavailable. The processor 201 transmits the first Unique-Number (N1) to the user device 103 through a secure, encrypted communication channel. On the user device 103, the first Unique-Number (N1) is stored in secure storage such as a secure enclave (for example, Apple's Secure Enclave on iOS devices), a trusted execution environment (TEE) such as ARM TrustZone, a hardware security module (HSM), or an encrypted storage partition protected by device-level encryption. Simultaneously, the processor 201 stores the first Unique-Number (N1) in the data repository 215, which is part of the data storage 212 within the system 101. The data repository 215 maintains a secure database of Unique-Numbers associated with registered users, indexed by the user's anonymized identifier to enable efficient retrieval during authentication processes. The data repository 215 may implement additional security measures such as encryption at rest using strong encryption algorithms such as AES-256, access control lists restricting access to authorized system components, audit logging recording all access attempts, database-level encryption, and secure key management systems protecting encryption keys.

At step 406, the processor 201 stores the first Public-Key (P1) on a storage device. The storage device may be the data storage 212 within the system 101, a dedicated key storage system, or distributed across multiple storage locations for redundancy. The processor 201 stores the first Public-Key (P1) in a manner that allows efficient retrieval during subsequent authentication processes and cryptographic operations. The storage may include additional metadata such as the key generation timestamp, key version number to support key rotation and updates, cryptographic algorithm identifier specifying which cryptographic Function (F1) was used, and key status indicating whether the key is active, suspended, or revoked. The processor 201 may implement key management policies such as key expiration requiring periodic re-registration, key rotation schedules for enhanced security, and key revocation mechanisms allowing users to invalidate keys if compromise is suspected.

Upon completion of step 406, the user registration process is complete. The processor 201 generates a registration record stored in the people registry 213, which maintains comprehensive records of all registered users including references to their stored Unique-Numbers (N1) in both the user device 103 and data repository 215, references to their stored Public-Keys (P1), registration timestamps, device identifiers, biometric factors used, and anonymized user identifiers that serve as internal references without revealing personally identifiable information. This registration record does not include the user's name, email address, phone number, social security number, or any other personally identifiable information, thereby protecting privacy while establishing verified identity on the system 101.

Now referring to FIG. 5, a method 500 for biometric authentication and affixing biometric signatures to target documents is illustrated, in accordance with an embodiment of the present subject matter. The method 500 corresponds to the biometric signature affixation process referenced in steps 305 and 308 of FIG. 3 and provides detailed steps for authenticating users in real-time and affixing their unforgeable biometric signatures to documents.

At step 501, the processor 201 receives a real-time biometric sample captured from the first user or the second user. The real-time biometric sample is captured at the moment when the user wishes to sign a document, as opposed to the biometric samples captured during initial registration. When a user wishes to sign a target document, the processor 201 executes programmed instructions of the biometric authentication module 209 to send an authentication request to the user's device 103. The user device 103 displays a prompt to provide biometric authentication, and the user complies by providing their biometric sample through the device's biometric sensors. The user device 103 captures the real-time biometric sample using its biometric sensors under current environmental conditions, which may differ from conditions during registration. The real-time biometric sample is transmitted to the system 101 via the I/O interface 202 through an encrypted communication channel to prevent man-in-the-middle attacks where an attacker might intercept the biometric sample for fraudulent authentication. The real-time biometric sample may be transmitted in raw format or processed format depending on whether biometric processing is performed on the user device 103 or on the system 101.

At step 502, the processor 201 processes the real-time biometric sample to generate a second Secret-Key (S2). The processing follows the same feature extraction and cryptographic processing algorithms used during initial user registration to ensure consistency and reproducibility. The processor 201 applies the same biometric feature extraction algorithms used in step 402 of FIG. 4 to analyze the real-time biometric sample and extract unique characteristics. The processor 201 normalizes the extracted features to account for variations in capture conditions such as different positioning, different environmental conditions, or changes in the biometric characteristic itself. The processor 201 then applies the same cryptographic processing used during registration to transform the extracted and normalized features into a cryptographic key, generating the second Secret-Key (S2).

The critical property of this process is that if the real-time biometric sample is truly from the same person who registered, then the second Secret-Key (S2) generated from the real-time sample will match the first Secret-Key (S1) that was generated during registration, despite minor variations in the biometric samples due to different capture conditions. This is achieved through the error-tolerance properties of fuzzy extractor algorithms, which are designed to produce the same output (Secret-Key) from similar but not identical inputs (biometric features). However, if an imposter tries to authenticate using their own biometric characteristics or a fake biometric, the fuzzy extractor will produce a different Secret-Key (S2≠S1), causing authentication to fail. It is important to note that the first Secret-Key (S1) from registration was never stored anywhere, so the processor 201 cannot directly compare S2 with S1, and instead the comparison is made indirectly through the Unique-Numbers as described in subsequent steps.

At step 503, the processor 201 fetches the first Public-Key (P1) from the storage device. The storage device is part of the data storage 212 where Public-Keys were stored during user registration in step 406 of FIG. 4. The processor 201 executes programmed instructions to retrieve the first Public-Key (P1) that corresponds to the user who is attempting to authenticate and sign the document. To identify which Public-Key to retrieve, the processor 201 uses identifying information from the authentication request, such as the user's anonymized user identifier, biometric hash, or device identifier. The processor 201 queries the key database within the data storage 212 to retrieve the stored Public-Key. The retrieval process may involve database queries, cache lookups for frequently accessed keys, or distributed storage queries if keys are stored across multiple storage nodes. The processor 201 implements efficient retrieval mechanisms to minimize authentication latency. Once retrieved, the Public-Key (P1) is loaded into the processor's working memory for use in the authentication computation.

At step 504, the processor 201 computes a Real-Time-Unique-Number (N2) using the first Public-Key (P1), the second Secret-Key (S2), and the cryptographic Function (F1). This computation represents the inverse or verification operation of the cryptographic Function used during registration. During registration in step 404 of FIG. 4, the relationship was P1=F1 (S1, N1), which computed the Public-Key from the Secret-Key and Unique-Number. During authentication, the processor 201 uses the inverse relationship to compute N2=F1_inverse (P1, S2), where F1_inverse represents the inverse operation or verification algorithm corresponding to the cryptographic Function F1.

The specific implementation of this inverse computation depends on the cryptographic system being used. In an RSA-based system, the inverse operation might involve modular exponentiation with the private exponent. In an ECC-based system, the inverse operation might involve point subtraction and scalar division on the elliptic curve. In a Diffie-Hellman based system, the inverse operation might involve discrete logarithm computation within a specific mathematical structure. If the user's real-time biometric sample is authentic (truly from the registered user), then S2 equals S1 (the Secret-Key from registration), which means the computed Real-Time-Unique-Number (N2) will equal the first Unique-Number (N1) that was stored during registration. If the biometric sample is from an imposter, then S2 will not equal S1, which means N2 will not equal N1.

At step 505, the processor 201 authenticates the first user or the second user based on comparison of the Real-Time-Unique-Number (N2) with the first Unique-Number (N1). The first Unique-Number (N1) was stored on the user device 103 and in the data repository 215 during the registration process in step 405 of FIG. 4. The processor 201 retrieves the first Unique-Number (N1) from one or both of these storage locations. In one implementation, the processor 201 retrieves from the user device 103 by sending a secure request asking the device to retrieve the stored Unique-Number from its secure storage and transmit it back through an encrypted channel. In another implementation, the processor 201 retrieves from the data repository 215 within the system 101's data storage 212 by querying using the user's anonymized identifier. In yet another implementation, the processor 201 retrieves from both locations and compares them to ensure consistency, providing an additional security check.

The processor 201 performs a direct numerical comparison between the Real-Time-Unique-Number (N2) computed in step 504 and the stored Unique-Number (N1). If N2 equals N1, this proves that the real-time biometric sample is from the same person whose biometric data was used during registration, that the Secret-Key (S2) generated from the real-time biometric sample matches the Secret-Key (S1) from registration, and that the user's identity is verified. In this case, authentication succeeds, and the processor 201 records the successful authentication event including timestamp, device identifier, and authentication method in authentication logs within the data storage 212.

If N2 does not equal N1, this proves that the real-time biometric sample is not from the same person who registered, that the Secret-Key (S2) from the real-time sample does not match the original Secret-Key (S1), and that the authentication attempt is fraudulent or erroneous. In this case, authentication fails, and the processor 201 records the failed authentication attempt in security logs and may implement security measures such as incrementing a failed attempt counter, temporarily locking the account after repeated failures, alerting security administrators about potential attack attempts, or requiring additional verification steps before allowing further authentication attempts.

At step 506, the processor 201, upon successful authentication, affixes the first biometric signature or the second biometric signature to the target document. This step is only performed if the authentication in step 505 was successful (N2 equals N1). If authentication failed, the processor 201 does not affix any signature and returns an error message indicating that authentication failed and the document cannot be signed. Upon successful authentication, the processor 201 proceeds to affix the biometric signature to the target document.

In one embodiment, the first biometric signature and the second biometric signature are each derived from a one-way hash of the respective biometric data combined with a unique nonce generated at the time of signing. This ensures that each signature is unique, time-bound, and document-specific, preventing signature replay attacks or signature copying. The processor 201 generates a unique nonce at the exact moment when the user approves signing the document. A nonce (number used once) is a random or pseudo-random number generated specifically for a single use and ensures that each signature instance is unique even if the same user signs multiple similar documents.

The processor 201 combines several elements to create the biometric signature: the user's biometric data or a hash thereof (such as a hash of the user's biometric features or the Secret-Key S2), the unique nonce generated at signing time, a hash of the target document to bind the signature to this specific document, and the current timestamp to bind the signature to this specific time. The processor 201 concatenates these elements into a single string and applies a one-way hash function such as SHA-256 or SHA-512 to generate the biometric signature. The computation produces a signature value that uniquely represents this signing event.

The processor 201 embeds this biometric signature into the target document as metadata. The embedding may involve adding the signature to the document's metadata fields in the file format, appending a signature block to the document content that includes the signature value, timestamp, and signer information, creating a digital signature wrapper around the document, or storing the signature in a separate signature database linked to the document by document identifier. The embedded signature includes several pieces of information: the biometric signature value itself, the timestamp when the signature was affixed, the signer's anonymized identifier (derived from biometric hash, not personally identifiable), the device identifier of the user device used for signing, the authentication method used (face, voice, fingerprint, etc.), and a reference to the stored Unique-Number and Public-Key used for authentication.

This biometric signature cannot be copied to another document because it includes the document hash as part of its computation, it cannot be reused at a different time because it includes the timestamp and nonce, and it cannot be forged because it requires the user's authentic biometric sample to generate the correct Secret-Key and pass authentication. The processor 201 updates the document status in the contract documents 217 to indicate that the document has been signed by this user. If this is the first signature on the document, the document status is updated to “partially signed” and awaits additional signatures. If this is the final required signature, the document status is updated to “fully executed” and the document becomes a countersigned document ready for blockchain storage.

The method 500 provides robust biometric authentication and signature affixation that ensures signatures are tied directly to the biological characteristics of signers, cannot be forged or transferred to others, are time-bound and document-specific, and provide strong legal evidence of the signer's identity and intent. The method 500 can be repeated for multiple signers on the same document, with each signer going through the same authentication and signature affixation process to add their biometric signature to the document.

Now referring to FIG. 6, a method 600 for creating business-customer accounts with privacy-aware communication address hash generation is illustrated, in accordance with an embodiment of the present subject matter. The method 600 corresponds to the business-customer account creation process referenced in step 303 of FIG. 3 and provides detailed steps for establishing secure, privacy-aware communication channels between business entities and customers.

At step 601, the processor 201 generates a cryptographic key-value pair comprising a customer public key and a customer private key. The creation of a business-customer account is typically initiated when a registered user wishes to engage in business transactions or contract execution with a registered business entity. The processor 201 executes programmed instructions of the account creation module 207 to generate a unique cryptographic key pair for this specific business-customer relationship using asymmetric encryption algorithms. The processor 201 may use RSA algorithm with key sizes of 2048 bits, 3072 bits, or 4096 bits for high security, ECC with curves such as secp256r1, secp384r1, or Curve25519 for efficient security with smaller key sizes, DSA for digital signature purposes, or ElGamal encryption for secure key exchange and encryption. The choice of algorithm may depend on system security policies, performance requirements, and compatibility considerations. The customer public key is used by the system 101 and the business entity to encrypt communications sent to the customer, while the customer private key is used by the customer to decrypt received communications. After generating the cryptographic key-value pair, the processor 201 securely transmits the customer private key to the customer's user device 103 through a secure, encrypted communication channel using end-to-end encryption, perfect forward secrecy, or other secure transmission protocols to prevent interception. Upon receipt, the user device 103 stores the customer private key in secure storage such as a secure enclave, trusted execution environment, or encrypted keychain. The processor 201 retains the customer public key in the system 101 for use in encrypting communications.

At step 602, the processor 201 creates a customer communication address for the first user. The customer communication address comprises a proxy email address or a proxy phone number that serves as an intermediary identifier for communications between the business entity and the customer. The proxy nature of the customer communication address is fundamental to the privacy-aware architecture, as it ensures that the customer's actual personal email address or phone number is never revealed to the business entity. The processor 201 generates a unique proxy address that is specific to this business-customer relationship using various strategies such as random string generation combined with a domain controlled by the system (for proxy email addresses), virtual phone number allocation from a pool of numbers controlled by the system (for proxy phone numbers), hash-based generation where a hash of the customer's identifier and business identifier is used to deterministically generate a unique proxy address, or sequential allocation where proxy addresses are assigned sequentially from available pools. For proxy email addresses, the processor 201 may generate addresses in formats such as “customer_[random_string]@[business_name]-contracts.com”, “proxy [sequential_number]@[system_domain].com”, or “[hash_value] @contracts. [system_domain].com”. For proxy phone numbers, the processor 201 may allocate virtual phone numbers from telephony service providers using technologies such as VoIP, SMS gateways, or virtual number services. The generated proxy address is unique to this specific business-customer relationship, does not reveal the customer's personal contact information, is controlled by the system 101 which can enforce policies and permissions, can be easily identified as belonging to this relationship through database lookups, and can be revoked or disabled if the customer wishes to terminate the business relationship without affecting other relationships or personal contact information. The processor 201 stores the customer communication address in the record 216 (which will be created in step 605) and associates it with the customer's anonymized identifier and the business entity's identifier to enable correct message routing.

At step 603, the processor 201 combines the business communication address with the customer communication address. The business communication address was stored in the business registry 214 when the business entity registered with the system 101. The processor 201 retrieves the business communication address from the business registry 214 using the business entity's identifier and then combines this business communication address with the customer communication address created in step 602. The combination is performed by concatenating the two addresses into a single string using a consistent format that will be used for all business-customer relationships. The processor 201 may use a delimiter such as pipe symbol “|”, colon “:”, or semicolon “;”, or may concatenate without delimiters, but consistency is essential as the same combination method must be used both when creating the account and when authenticating subsequent communications. The order of combination is also important and must be consistent, with the processor 201 either always placing the business communication address first followed by the customer communication address, or vice versa. This combined string represents the unique communication relationship between this specific business entity and this specific customer, and no other business-customer pair will have the same combined string, making it an ideal input for generating a unique authentication hash.

At step 604, the processor 201 applies a hashing algorithm to the combination to generate a business-customer communication address hash. The hashing algorithm corresponds to a one-way hash function that takes an input of arbitrary length and produces a fixed-size output (hash value) in such a way that it is computationally infeasible to reverse the process and derive the original input from the hash output. The processor 201 may use cryptographically secure hashing algorithms such as SHA-256 which produces a 256-bit hash value, SHA-512 which produces a 512-bit hash value, SHA-3, Blake2 or Blake3 which are modern fast cryptographic hash functions, or other collision-resistant hash functions approved for cryptographic use. The processor 201 applies the chosen hashing algorithm to the combined string from step 603 to produce the business-customer communication address hash. This hash value has several critical properties that make it ideal for authentication: uniqueness (because the combined input string is unique to this business-customer relationship, the hash output is also unique), determinism (the same input always produces the same output, enabling reliable authentication), one-way property (it is computationally infeasible to reverse the hash and derive the original addresses from the hash value), collision resistance (it is computationally infeasible to find two different input strings that produce the same hash value), and avalanche effect (even a tiny change in the input produces a completely different hash output, providing strong protection against tampering or address spoofing).

At step 605, the processor 201 generates a record in memory comprising the business-customer communication address hash and the customer public key. This record, referred to as record 216, is the central data structure that enables privacy-aware authenticated communication for this business-customer relationship. The processor 201 creates a new entry in the record 216 database within the data storage 212 containing the business-customer communication address hash which serves as the authentication token for verifying all communications between this business entity and customer, and the customer public key which will be used to encrypt all communications sent to the customer. The record 216 may also include additional metadata and configuration information such as account creation timestamp recording when this business-customer relationship was established, business entity identifier referencing the business entity in the business registry 214, customer identifier referencing the customer in the people registry 213, the customer communication address (proxy address) for this relationship, the business communication address, customer promotion preference flag indicating whether the customer has opted to receive promotional communications in addition to transactional communications, account status indicating whether the relationship is active, suspended, or terminated, communication permissions defining what types of communications are allowed, contract history references linking to contracts executed between the parties, and expiration date if the business-customer relationship has time-limited scope. The processor 201 stores the record 216 in the data storage 212 with appropriate indexing to enable efficient retrieval during communication authentication, indexed by the business-customer communication address hash for fast authentication lookups, the business entity identifier to find all customers of a particular business, the customer identifier to find all businesses that a customer has relationships with, or the customer communication address to route incoming messages to the correct customer.

At step 606, the processor 201 stores the business-customer account record for future authentication. This step involves persisting the record 216 created in step 605 to permanent storage and ensuring its availability for subsequent communication authentication operations. The processor 201 commits the record 216 to the database within the data storage 212, ensuring that the record survives system restarts, failures, or other disruptions. The processor 201 may implement database replication or backup mechanisms to protect the record 216 from loss, such as replicating the record across multiple database servers in different geographic locations to ensure availability even if one server fails. The processor 201 may also implement database transaction mechanisms to ensure that the record creation is atomic and consistent, with either the complete record successfully stored or no record created at all, preventing partial or corrupted records. The processor 201 notifies both the customer and the business entity that the business-customer account has been successfully created, informing them that they can now exchange documents and execute contracts through the secure platform. Upon completion of step 606, the business-customer account is fully established and operational, enabling the business entity to send contract documents to the customer through the proxy communication address, the system 101 to authenticate these communications using the business-customer communication address hash, and the system 101 to encrypt these communications using the customer public key before delivering them. Throughout this entire process, the customer's personal email address and phone number remain completely hidden from the business entity, protecting privacy while enabling secure business communications and contract execution. The method 600 can be repeated for each new business-customer relationship that needs to be established, with a single customer potentially having multiple business-customer accounts with different business entities and a single business entity potentially having multiple business-customer accounts with different customers, where each business-customer account has its own unique cryptographic key pair, unique proxy communication address, and unique communication address hash, ensuring that each relationship is isolated and secured independently.

Now referring to FIG. 7, a method 700 for transmitting target documents via encrypted communication channels with communication authentication is illustrated, in accordance with an embodiment of the present subject matter. The method 700 corresponds to the document transmission and communication authentication process referenced in step 306 of FIG. 3 and provides detailed steps for ensuring that documents are transmitted only through verified, encrypted channels to authorized recipients while blocking unauthorized communication attempts.

At step 701, the processor 201 extracts communication addresses from a communication request. When a first user has signed a target document and the system 101 needs to transmit this signed document to a second user, a communication request is generated that contains addressing information for both the sender and recipient. The processor 201 executes programmed instructions of the communication authentication module 210 to process this communication request and extract the relevant addressing information. The communication request may be generated by various mechanisms such as the contract execution module 208 after the first user successfully signs a document, initiation by the business entity acting as an intermediary requesting document routing, or triggering by a workflow rule in a messaging group environment that specifies the sequential signing order. The processor 201 identifies and extracts a first communication address associated with the business entity, corresponding to the business communication address that was registered in the business registry 214 when the business entity registered with the system 101. The processor 201 also identifies and extracts a second communication address associated with the customer, corresponding to the customer communication address (proxy address) that was created when the business-customer account was established in step 602 of FIG. 6. The specific proxy address extracted depends on which customer is the recipient of this communication. The communication request may contain additional information that the processor 201 extracts for processing, such as the document identifier uniquely identifying which document is being transmitted, the sender identifier indicating who is sending the document, the recipient identifier indicating who should receive the document, transmission priority indicating urgency or delivery preferences, encryption preferences specifying encryption methods or key strengths, and workflow metadata indicating the document's position in a multi-party signing workflow.

At step 702, the processor 201 generates a communication address hash using the hashing algorithm based on a combination of the communication addresses. The processor 201 performs the same address combination and hashing process that was used during business-customer account creation in steps 603-604 of FIG. 6, ensuring consistency in hash generation for authentication purposes. The processor 201 combines the first communication address and the second communication address using the same concatenation method and format that was used during account creation, then applies the same hashing algorithm (typically SHA-256, SHA-512, or another cryptographically secure one-way hash function) to this combined string to produce the communication address hash. This communication address hash represents the authentication token for this specific communication attempt. If this communication is legitimate (the business entity sending a document to the customer through the authorized proxy address), then this hash will match the business-customer communication address hash that was generated and stored when the business-customer account was created. If this communication is fraudulent or uses spoofed addresses, the hash will not match and the communication will be blocked. The one-way property of the hash function is critical, as an attacker who wants to send a fraudulent document cannot simply observe communications and copy the hash value, because the hash is generated fresh for each communication attempt based on the actual addresses used, and if the attacker uses even slightly different addresses, the generated hash will be completely different and will fail the authentication check.

At step 703, the processor 201 compares the communication address hash with the business-customer communication address hash from the record. This comparison step is the core authentication mechanism that determines whether the communication attempt is authorized and legitimate. The processor 201 retrieves the business-customer communication address hash that was stored in the record 216 when the business-customer account was created in step 605 of FIG. 6. The processor 201 queries the data storage 212 to retrieve the record 216 for the business-customer relationship, using search keys such as the recipient's proxy address to find the corresponding record, the business entity identifier and customer identifier combination to locate the record, or an indexed lookup optimized for fast retrieval during high-volume communication processing. The processor 201 performs a direct byte-by-byte comparison between the newly generated communication address hash from step 702 and the stored business-customer communication address hash retrieved from record 216. If the hash values match exactly, this proves several critical security properties: the communication is occurring between the exact business entity and customer who established this business-customer account with addresses matching those used during account creation, no unauthorized party is attempting to intercept or redirect the communication, the communication addresses have not been spoofed or tampered with due to the extreme sensitivity of hash functions to input changes, the business entity is legitimately authorized to send communications to this customer through this proxy address, and the customer's actual personal email address or phone number has not been compromised or exposed as all communication occurs through the verified proxy address. If the hash values do not match, this indicates a security problem such as the communication being from an unauthorized sender attempting to impersonate the business entity, the communication addresses being spoofed or tampered with during transmission, the communication being directed to an incorrect or non-existent proxy address, or a system error or data corruption affecting the addresses or hashes.

At step 704, the processor 201, upon matching, encrypts the target document using the customer public key. This step is only performed if the hash comparison in step 703 was successful, otherwise the processor 201 skips to step 706 and blocks the communication attempt. If the hashes matched, the processor 201 proceeds with encrypting the document for secure transmission. The processor 201 retrieves the customer public key from the record 216, which was stored during business-customer account setup in step 605 of FIG. 6 and is readily available from the same record already retrieved in step 703. The processor 201 retrieves the target document from the contract documents 217 in the data storage 212, including the document content, the first user's biometric signature that was affixed, document metadata including document identifier, creation timestamp, version number, and signing history, and any attachments or supporting materials. The processor 201 applies asymmetric encryption to the target document using the customer public key, where asymmetric encryption (also known as public-key encryption) uses a public key for encryption and requires the corresponding private key for decryption, with the mathematical relationship ensuring that data encrypted with the public key can only be decrypted using the matching private key. The encryption process may involve a hybrid encryption approach for large documents, where the processor 201 generates a random symmetric encryption key (such as an AES-256 key), encrypts the document content using this symmetric key which is fast for large data, encrypts the symmetric key itself using the customer public key through asymmetric encryption, and packages both the encrypted document and the encrypted symmetric key together. This hybrid approach combines the efficiency of symmetric encryption for large data with the security benefits of asymmetric key distribution. The encryption ensures that even if the transmission is intercepted during transit over the communication network 104, the interceptor cannot read the document contents because they would need the customer private key to decrypt the symmetric key, and without the symmetric key they cannot decrypt the document content, and since the customer private key is stored securely in the customer's user device 103 and has never been transmitted over the network or shared with anyone, the document remains confidential even if intercepted. The encryption also provides integrity protection, as the processor 201 may include digital signatures or message authentication codes (MACs) in the encryption process to detect if the encrypted document is tampered with during transmission, with any modification to the encrypted data being detected when the customer attempts to decrypt it.

At step 705, the processor 201 transmits the encrypted target document to the second user. The processor 201 sends the encrypted transmission package created in step 704 to the second user's device 103 through the communication network 104 via multiple possible communication channels depending on system configuration and user preferences. For email-based transmission, the processor 201 sends an email message to the customer's proxy email address with the email system routing through the communication network 104 to the user device 103 where it is received by a dedicated application or email client configured to process documents from the system 101. For SMS/text message-based transmission, the processor 201 sends a text message to the customer's proxy phone number containing either the encrypted document as an attachment or a secure link to download the encrypted document from the system 101. For instant messaging-based transmission, the processor 201 sends the encrypted document through a messaging platform that the customer has connected to the system 101 using the messaging platform's APIs and protocols. For application-based transmission which may be the most secure method, the processor 201 sends a push notification to the dedicated application installed on the customer's user device 103 alerting them that a new document requiring review and signature has arrived, and the application then establishes a secure connection to the system 101 and downloads the encrypted document directly from the contract documents 217 storage using mutual TLS (mTLS) authentication to ensure the connection is secure and authenticated in both directions. The transmission includes not just the encrypted document but also associated metadata that helps the customer's device process the document correctly, such as the sender's anonymized identifier so the customer knows who sent the document, the document type and category, transmission timestamp, priority or urgency indicators, workflow position indicating if additional signatures are still needed and from whom, decryption instructions specifying which private key to use, and references to the business-customer account and record 216 for verification purposes. When the customer's device receives the encrypted transmission package, the dedicated application retrieves the customer private key from the device's secure storage, decrypts the symmetric key using the private key, decrypts the document content using the symmetric key, displays the decrypted document to the customer showing the document with any existing signatures, and provides options to review the document, sign it if approved, or reject it if the terms are not agreeable. The processor 201 may send notifications through multiple channels to ensure the customer is aware of the document arrival, such as notification email to the customer's registered notification email address, SMS notification to registered phone number, push notification through mobile application, or in-app notification when next logging into the system 101, informing the customer about the received document requiring signature and any applicable deadline for review.

At step 706, the processor 201 blocks communication attempts if the address hashes do not match. This step implements the security enforcement mechanism that prevents unauthorized or fraudulent communications from reaching users and represents the alternative path taken when the hash comparison in step 703 fails (the newly generated communication address hash does not match the stored business-customer communication address hash from the record 216). When the processor 201 detects a hash mismatch in step 703, it immediately terminates the communication process and prevents the document from being encrypted or transmitted. The processor 201 executes programmed instructions of the communication authentication module 210 to implement blocking actions and security responses. The processor 201 logs the blocked communication attempt in security logs within the data storage 212, with the security log entry including detailed information such as timestamp of the attempted communication, extracted communication addresses (both the claimed business address and customer proxy address), the generated communication address hash that failed to match, the sender's claimed identity or IP address, the document identifier if available, the target recipient, and any other metadata from the communication request. The processor 201 may increment a security counter for failed authentication attempts, and if multiple failed attempts occur from the same source or targeting the same recipient within a short time period indicating an active attack, the processor 201 may implement progressive security responses based on the number of failed attempts, such as temporarily blocking the source IP address after multiple failed attempts within a time window, suspending the targeted business-customer account after numerous failed attempts to protect the customer from sustained attack, alerting security administrators after a threshold of failed attempts for manual review, or requiring additional verification (such as biometric re-authentication) before allowing future communications to this recipient after repeated attack attempts. The processor 201 may send a security alert to the intended recipient informing them that an unauthorized communication attempt was blocked because it failed authentication and that the document was not delivered, with instructions to contact the business entity directly if expecting a document. The processor 201 may also send a notification to the legitimate business entity informing them that someone attempted to send a communication using their business address but failed authentication, helping the business entity detect if their email domain is being spoofed for phishing or fraud attempts. The processor 201 may implement additional security measures for high-threat scenarios, such as adding the source to a blocklist preventing any future communication attempts from that source, performing threat intelligence sharing by reporting the attack attempt to security information sharing platforms or other participating organizations to help protect the broader ecosystem, and triggering enhanced monitoring by increasing logging verbosity and scrutiny for all communications involving the targeted recipient or business entity for a period of time. Importantly, the processor 201 ensures that the blocked communication never reaches the intended recipient, with the document not decrypted, not transmitted, and not stored in the recipient's contract documents, protecting the recipient from exposure to potentially fraudulent or malicious content. This blocking mechanism based on the business-customer communication address hash authentication provides strong protection against phishing attacks where attackers send fraudulent documents claiming to be from legitimate business entities, man-in-the-middle attacks where attackers attempt to intercept and modify communications between parties, address spoofing attacks where attackers use email addresses similar to legitimate business addresses, and unauthorized communications from parties who do not have an established business-customer relationship with the recipient. The method 700 provides comprehensive communication authentication that ensures documents are transmitted only through verified channels to authorized recipients while blocking fraudulent or unauthorized communication attempts, combining the privacy-aware proxy addressing system with cryptographic hash-based authentication to create a secure communication infrastructure that protects users from a wide range of threats while maintaining their privacy by never exposing their actual personal contact information to business entities.

Now referring to FIG. 8, a method 800 for storing records of countersigned documents on blockchain for permanent immutable storage is illustrated, in accordance with an embodiment of the present subject matter. The method 800 corresponds to the blockchain storage process referenced in step 310 of FIG. 3 and provides detailed steps for anchoring executed contracts to blockchain networks in a manner that ensures permanent, tamper-proof recordkeeping.

At step 801, the processor 201 generates a cryptographic hash of the countersigned document. This step is performed after both users have successfully affixed their biometric signatures to the target document, transforming it into a countersigned document representing a fully executed contract. The processor 201 executes programmed instructions coordinated by the contract execution module 208 to initiate the blockchain storage process. The processor 201 retrieves the fully executed countersigned document from the contract documents 217 in the data storage 212, including the complete original document content comprising all text, terms, conditions, clauses, and specifications of the contract, the first biometric signature affixed by the first user including signature value, timestamp, device identifier, and authentication data, the second biometric signature affixed by the second user including signature value, timestamp, device identifier, and authentication data, any attachments, exhibits, or supporting documents that are part of the contract, and document formatting, layout, and structure information that preserves the visual presentation of the contract. The processor 201 applies a cryptographic hashing algorithm to the complete countersigned document to generate a cryptographic hash, where the cryptographic hashing algorithm is a one-way function that takes an input of arbitrary length and produces a fixed-size output (the hash value) in such a way that it is computationally infeasible to reverse the process or to find two different inputs that produce the same hash value. The processor 201 may use industry-standard cryptographic hash functions such as SHA-256 (Secure Hash Algorithm 256-bit) which produces a 256-bit hash value and is widely used in blockchain systems like Bitcoin, SHA-512 (Secure Hash Algorithm 512-bit) which produces a 512-bit hash value for enhanced security, SHA-3 (the latest member of the Secure Hash Algorithm family) offering improved security properties, Keccak-256 which is used in Ethereum and other blockchain platforms, or Blake2 or Blake3 which are modern, fast cryptographic hash functions. The processor 201 converts the countersigned document into a standardized binary format or canonical representation before hashing to ensure consistency, as the same document content might be represented in different ways in different file formats or encodings, and converting to a canonical form ensures that the same document content always produces the same hash value regardless of incidental formatting variations. This cryptographic hash serves as a unique digital fingerprint of the countersigned document and has several critical properties for blockchain storage: the hash value is deterministic (the same document content always produces exactly the same hash value, enabling reliable verification), the hash function exhibits the avalanche effect (even a tiny change to the document produces a completely different hash value, making any tampering immediately detectable), the hash is unique and collision-resistant (it is computationally infeasible to find two different documents that produce the same hash value, ensuring that each contract has a unique identifier), the hash is one-way (it is computationally infeasible to reverse-engineer or reconstruct the original document from the hash value, protecting document confidentiality when the hash is stored publicly on a blockchain), and the hash is fixed-size (producing a consistent output length regardless of the input document size, making it efficient to store on blockchain systems that charge fees based on data size).

At step 802, the processor 201 generates transaction metadata comprising signatory identifiers, timestamps, device identifiers, and other transaction parameters. The transaction metadata provides contextual information about the contract execution that supplements the document hash, enabling future verification and providing an audit trail of the signing process. The processor 201 compiles signatory identifiers for all parties who signed the document, where the signatory identifiers are anonymized references to the signers derived from their biometric hashes rather than personally identifiable information, protecting signer privacy even when the metadata is stored on a public blockchain. The processor 201 compiles timestamps for each signature event with precise date and time information, which are critical for legal validity of contracts as they establish when each party manifested their intent to be bound by the agreement. The processor 201 may use multiple timestamp sources for enhanced reliability, such as system timestamps from the system 101's synchronized clock, blockchain timestamps from when the transaction is included in a block, trusted timestamp authority (TSA) timestamps from third-party time-stamping services that provide legally recognized time proofs, and device timestamps from the user devices 103 where the biometric authentication occurred. The processor 201 compiles device identifiers for the devices used during the signing process, providing additional verification of the signing events that can be useful in dispute resolution to establish that signatures were affixed using specific, registered devices. The device identifiers may include hardware identifiers such as IMEI (International Mobile Equipment Identity) for mobile devices, MAC addresses for network interfaces, device serial numbers, or secure hardware identifiers from secure enclaves or TPMs (Trusted Platform Modules). The processor 201 compiles other transaction parameters that provide additional context and facilitate contract management, such as the contract type or category (enabling classification and retrieval of contracts by type), the business entity identifier referencing the business entity that facilitated the contract, the jurisdiction or governing law applicable to the contract, the contract value or consideration amount if applicable, the system reference identifier providing a unique internal reference for the contract within the system 101, the document version number if the contract went through multiple revisions before execution, related document references if this contract is part of a series or related to other contracts, and compliance flags indicating regulatory compliance requirements that apply to this contract (such as HIPAA, GDPR, SOX). The processor 201 structures this complete transaction metadata in a format suitable for blockchain submission, combining all signatory identifiers, timestamps, device identifiers, authentication methods used, contract type and business entity information, jurisdiction and contract value details, and system reference identifiers into a comprehensive metadata record.

At step 803, the processor 201 generates a transaction record comprising the cryptographic hash and the transaction metadata. The transaction record is the complete data structure that will be submitted to the blockchain network for permanent storage. The processor 201 combines the document hash generated in step 801 and the transaction metadata compiled in step 802 into a single structured record. The transaction record may be formatted in various ways depending on the blockchain platform being used, such as formatting as a JSON (JavaScript Object Notation) document that contains the hash and metadata in a structured, human-readable format for blockchain platforms that support arbitrary data storage, formatting as an XML (extensible Markup Language) document that provides structured data with schema validation, formatting as a Protocol Buffer or similar binary serialization format for efficient encoding, or formatting as a custom binary format optimized for the specific blockchain's data structure. For blockchain platforms that have limited data storage capabilities or high storage costs, the processor 201 may use more compact representations such as encoding the transaction record as a compact binary format with minimal overhead, storing only essential fields to reduce blockchain transaction costs, or using off-chain storage combined with on-chain hash references where the full metadata is stored in the system 101's data storage 212 or in decentralized file storage systems like IPFS (InterPlanetary File System) and only a reference hash is stored on the blockchain. The processor 201 may cryptographically sign the transaction record using the system 101's private key before submission to the blockchain, with this signature proving that the transaction record originated from the legitimate system 101 and has not been tampered with, providing an additional layer of authenticity beyond the blockchain's own integrity guarantees. The processor 201 generates a complete transaction record that packages the document hash and all metadata into a structure ready for blockchain submission, including record type and version information, the document hash serving as the unique identifier, all transaction metadata with signatory information, timestamps, device identifiers, contract details, and other parameters, system signature for authenticity verification, and submission timestamp recording when the record is being submitted to the blockchain.

At step 804, the processor 201 writes the transaction record on a blockchain for permanent immutable storage. This step involves submitting the transaction record to the blockchain network 105 and having it permanently recorded in the blockchain's distributed ledger. The processor 201 interacts with the blockchain 105 through blockchain-specific APIs, SDKs (Software Development Kits), or node connections. The specific process for writing to the blockchain depends on which blockchain platform is being used, as the system 101 may support multiple blockchain networks allowing users or business entities to choose which blockchain to use based on factors such as transaction costs, confirmation speed, privacy features, or regulatory requirements, and the processor 201 adapts its blockchain submission process based on the selected blockchain platform. For public blockchain platforms like Bitcoin, the processor 201 creates a Bitcoin transaction that includes the transaction record in the OP_RETURN output field (which allows up to 80 bytes of arbitrary data) or in another data storage mechanism supported by Bitcoin, broadcasts the transaction to Bitcoin nodes through the Bitcoin network protocol, with Bitcoin miners including the transaction in a block and adding the block to the Bitcoin blockchain through the proof-of-work consensus mechanism, and once the block is confirmed (typically after 6 confirmations, which takes about 1 hour), the transaction record is permanently stored and considered immutable. For public blockchain platforms like Ethereum, the processor 201 creates an Ethereum transaction that calls a smart contract function or stores data directly in the transaction data field where the smart contract may be specifically designed for contract registration and verification, signs the transaction with the system 101's Ethereum private key and submits it to Ethereum nodes, with Ethereum validators (miners or stakers depending on whether proof-of-work or proof-of-stake is being used) including the transaction in a block and adding the block to the Ethereum blockchain, and once the block is confirmed (typically after 12-30 confirmations, which takes about 3-6 minutes), the transaction record is permanently stored. For private or permissioned blockchain platforms like Hyperledger Fabric, Corda, or Quorum, the processor 201 submits the transaction record to authorized validator nodes that participate in the blockchain network where the private blockchain may be operated by a consortium of organizations, with the consensus mechanism (such as PBFT—Practical Byzantine Fault Tolerance, RAFT, or other consortium consensus algorithms) validating and committing the transaction to the blockchain, and confirmation typically occurring within seconds or minutes depending on the specific blockchain configuration. The processor 201 performs the blockchain submission by connecting to the blockchain network using appropriate libraries or tools, preparing the transaction with proper formatting including the transaction record data, sender address, recipient address or smart contract address, and transaction parameters such as gas price and gas limit for networks that require these, signing the transaction using the system 101's blockchain private key to produce a cryptographic signature proving the transaction originated from the system 101, submitting the signed transaction to blockchain nodes through node connections or APIs with the transaction entering the blockchain's mempool where it awaits inclusion in a block, and monitoring the transaction status as validators select the transaction from the mempool and include it in a block which is added to the blockchain through the consensus mechanism. The blockchain network assigns a unique transaction identifier (also called transaction hash or transaction ID) to the submitted transaction that uniquely identifies the location of the stored record within the blockchain.

At step 805, the processor 201 confirms blockchain transaction submission and receives a transaction identifier. After submitting the transaction record to the blockchain network in step 804, the processor 201 monitors the blockchain to confirm that the transaction has been successfully included in a block and is progressing toward finality. The processor 201 tracks the transaction status through multiple stages, initially with the transaction in the “pending” state where it has been submitted to the blockchain network but not yet included in a block and resides in the mempool awaiting selection by validators or miners. The processor 201 monitors how many confirmations the transaction has received, with each confirmation representing an additional block added to the blockchain after the block containing the transaction, increasing confidence in the transaction's permanence. Once the transaction reaches the desired number of confirmations (which depends on the blockchain platform and security requirements), the processor 201 considers the transaction finalized and permanently stored on the blockchain. The blockchain network provides the transaction identifier that uniquely identifies the location of the stored record within the blockchain, serving as a permanent reference that can be used to retrieve and verify the stored transaction record at any future time. Using this transaction identifier, anyone can query the blockchain (through block explorers or direct node queries) to retrieve the stored transaction record and verify the contract's existence, authenticity, and execution details. The processor 201 records the successful blockchain submission in the system 101's internal logs, with the log entry including the document identifier, blockchain network used, transaction identifier, submission timestamp, confirmation timestamp, number of confirmations received, and gas costs or transaction fees paid.

At step 806, the processor 201 stores the blockchain reference in the system for future contract verification and dispute resolution. The processor 201 creates a permanent link between the countersigned document stored in contract documents 217 and its blockchain record stored on blockchain 105, enabling efficient future verification and providing users with easy access to the blockchain proof of their executed contracts. The processor 201 updates the document record in contract documents 217 to include blockchain reference information such as the blockchain transaction identifier that uniquely identifies the location of the contract record on the blockchain, the blockchain network name indicating which blockchain was used, the block number in which the transaction was included, the block timestamp indicating when the block was created, the blockchain confirmation count indicating the level of finality, and the blockchain explorer URL providing a direct link to view the transaction on a public blockchain explorer website. The processor 201 sends notifications to all parties involved in the contract informing them that the contract has been successfully executed and permanently recorded on the blockchain, with the notification providing the transaction identifier and explaining that the contract can be verified at any time using this identifier and that the contract is now tamper-proof and permanently preserved. The blockchain anchoring provides several critical benefits for contract enforceability and dispute resolution: immutability (once stored on the blockchain, the contract record cannot be altered, deleted, or tampered with due to the cryptographic and consensus mechanisms of the blockchain, ensuring that the evidence of the executed contract is permanently preserved), independent verification (anyone can independently verify the contract's existence and authenticity by querying the blockchain using the transaction identifier without needing to trust the system 101 or any other party), decentralization (the blockchain record is maintained by multiple nodes in a distributed network, ensuring that contract records survive even if the system 101 or individual blockchain nodes fail or are compromised), timestamp proof (the blockchain provides cryptographically verifiable proof of when the contract was executed, which can be critical for legal validity and dispute resolution), and long-term preservation (blockchain records can be expected to persist for decades or longer, ensuring that contract evidence remains available far into the future even if the system 101 ceases operation). For future verification or dispute resolution, the processor 201 can retrieve the blockchain record at any time by retrieving the transaction identifier from the document record in contract documents 217, querying the blockchain using the transaction identifier to retrieve the stored transaction record, verifying that the document hash in the blockchain record matches the hash of the current document to confirm that the document has not been altered since execution, presenting the blockchain record as cryptographic proof of the contract's execution including the timestamps and signatory identifiers, and if needed, the parties can be re-authenticated biometrically to confirm that they were indeed the signers using the re-authentication capability described in the method 500 of FIG. 5. The method 800 provides a robust blockchain storage mechanism that ensures executed contracts are permanently and immutably recorded, providing strong evidence for legal enforceability and protection against repudiation, tampering, or loss. By combining the biometric authentication system (which ensures signatures are from real people and cannot be forged), the privacy-aware communication system (which protects user privacy throughout the contracting process), and the blockchain storage system (which ensures permanent, tamper-proof recordkeeping), the overall system 101 provides a comprehensive solution for executing cryptographically verifiable contracts that addresses all major security, privacy, and auditability concerns in digital contracting.

Although implementations for the system 101 and the method 300 for executing cryptographically verifiable contracts, has been described in language specific to structural features and methods, it must be understood that the claims are not limited to the specific features or methods described. Rather, the specific features and methods are disclosed as examples of implementations for the system 101 and the method 300 for anonymized authenticated voting.

1. A system for executing biometrically signed cryptographically verifiable blockchain-anchored contracts on a privacy-aware messaging platform, the system comprising:
a memory;
a processor coupled with the memory, wherein the processor is configured to execute programmed instructions stored in the memory, the programmed instructions comprising:
a people registry module configured for registering a first user based on a user registration process;
a business registry module configured for registering a business entity by receiving and storing a business communication address associated with the business entity;
an account creation module configured for creating a business-customer account by:
generating a cryptographic key-value pair comprising a customer public key and a customer private key,
creating a customer communication address for the first user,
generating a business-customer communication address hash by applying a hashing algorithm to a combination of the business communication address and the customer communication address, and
generating a record in memory comprising the business-customer communication address hash and the customer public key;
a contract execution module configured for receiving a target document from the first user;
a biometric authentication module configured for affixing a first biometric signature to the target document by biometrically authenticating the first user and, upon successful authentication, affixing the first biometric signature;
a communication authentication module configured for transmitting the target document with the first biometric signature to a second user registered based on the user registration process, wherein the target document is transmitted via an encrypted communication channel by:
extracting communication addresses from a communication request,
generating a communication address hash using the hashing algorithm based on a combination of the communication addresses,
comparing the communication address hash with the business-customer communication address hash from the record,
upon matching, encrypting the target document using the customer public key, and
transmitting the encrypted target document to the second user, wherein the biometric authentication module is further configured for biometrically authenticating the second user, upon receipt of the target document by the second user;
wherein the contract execution module is further configured for:
presenting the target document to the second user upon successful authentication;
affixing to the target document a second biometric signature by the second user;
transmitting a countersigned document comprising the first biometric signature and the second biometric signature, back to the first user, via the encrypted communication channel; and
storing a record of the countersigned document on a blockchain.

2. The system of claim 1, wherein the user registration process corresponding to the first user or the second user comprises:
receiving a first set of biometric samples of the first user or the second user corresponding to one or more biometric factors;
processing the first set of biometric samples to compute a first Secret-Key (S1) corresponding to the first user or the second user;
generating a first Unique-Number (N1) using a random number generation algorithm;
applying a cryptographic Function (F1) to the first Secret-Key (S1) and the first Unique-Number (N1) to compute a first Public-Key (P1);
storing the first Unique-Number (N1) on a user device of the first user or the second user and in a data repository; and
storing the first Public-Key (P1) on a storage device.

3. The system of claim 2, wherein affixing the first biometric signature or the second biometric signature comprises:
receiving a real-time biometric sample captured from the first user or the second user;
processing the real-time biometric sample to generate a second Secret-Key (S2);
fetching the first Public-Key (P1) from the storage device;
computing a Real-Time-Unique-Number (N2) using the first Public-Key (P1), the second Secret-Key (S2) and the cryptographic Function (F1);
authenticating the first user or the second user based on comparison of the Real-Time-Unique-Number (N2) with the first Unique-Number (N1); and
upon successful authentication, affixing the first biometric signature or the second biometric signature to the target document.

4. The system of claim 3, wherein storing the record on the blockchain comprises:
generating a cryptographic hash of the countersigned document;
generating transaction metadata comprising signatory identifiers, timestamps, device identifiers, and other transaction parameters;
generating a transaction record comprising the cryptographic hash and the transaction metadata; and
writing the transaction record on a blockchain for permanent immutable storage.

5. The system of claim 1, wherein the one or more biometric factors correspond to face, voice, retina, iris, fingerprint, and palm vein, wherein the business communication address comprises an email address or a phone number, wherein the customer communication address comprises a proxy email address or a proxy phone number, and wherein the hashing algorithm corresponds to a one-way hash function.

6. The system of claim 1, wherein transmitting via the encrypted communication channel occurs within a messaging group environment configured with permissioning rules that define which users may view, comment on, endorse, recommend, edit, or sign the target document, and wherein the messaging group environment supports sequential and non-sequential signing workflows and role-based permissions for multiple users.

7. The system of claim 1, further comprising re-authenticating at least one of the first user or the second user at a later time to verify the countersigned document by receiving verification biometric samples, processing the verification biometric samples to regenerate authentication data, and comparing the regenerated authentication data with stored authentication data to confirm validity of the countersigned document.

8. The system of claim 1, wherein the first biometric signature and the second biometric signature are each derived from a one-way hash of the respective biometric data combined with a unique nonce generated at the time of signing, wherein receiving the target document comprises receiving a document signing request generated upon scanning a machine-readable code, and further comprising blocking all subsequent communication attempts if the communication address hash does not match with the business-customer communication address hash.

9. The system of claim 1, wherein the system is implemented across a distributed messaging network, and wherein every user action within the network is biometrically authenticated, cryptographically signed, and recorded on a blockchain.

10. A method of executing biometrically signed cryptographically verifiable blockchain-anchored contracts on a privacy-aware messaging platform, the method comprising:
registering a first user based on a user registration process;
registering a business entity by receiving and storing a business communication address associated with the business entity;
creating a business-customer account by:
generating a cryptographic key-value pair comprising a customer public key and a customer private key,
creating a customer communication address for the first user,
generating a business-customer communication address hash by applying a hashing algorithm to a combination of the business communication address and the customer communication address, and
generating a record in memory comprising the business-customer communication address hash and the customer public key;
receiving a target document from the first user;
affixing a first biometric signature to the target document by biometrically authenticating the first user and, upon successful authentication, affixing the first biometric signature;
transmitting the target document with the first biometric signature to a second user registered based on the user registration process, wherein the target document is transmitted via an encrypted communication channel by:
extracting communication addresses from a communication request,
generating a communication address hash using the hashing algorithm based on a combination of the communication addresses,
comparing the communication address hash with the business-customer communication address hash from the record,
upon matching, encrypting the target document using the customer public key, and
transmitting the encrypted target document to the second user, and biometrically authenticating the second user, upon receipt of the target document by the second user;
presenting the target document to the second user upon successful authentication;
affixing to the target document a second biometric signature by the second user;
transmitting a countersigned document comprising the first biometric signature and the second biometric signature, back to the first user, via the encrypted communication channel; and
storing a record of the countersigned document on a blockchain.

11. The method of claim 10, wherein the user registration process corresponding to the first user or the second user comprises:
receiving a first set of biometric samples of the first user or the second user corresponding to one or more biometric factors;
processing the first set of biometric samples to compute a first Secret-Key (S1) corresponding to the first user or the second user;
generating a first Unique-Number (N1) using a random number generation algorithm;
applying a cryptographic Function (F1) to the first Secret-Key (S1) and the first Unique-Number (N1) to compute a first Public-Key (P1);
storing the first Unique-Number (N1) on a user device of the first user or the second user and in a data repository; and
storing the first Public-Key (P1) on a storage device.

12. The method of claim 11, wherein affixing the first biometric signature or the second biometric signature comprises:
receiving a real-time biometric sample captured from the first user or the second user;
processing the real-time biometric sample to generate a second Secret-Key (S2);
fetching the first Public-Key (P1) from the storage device;
computing a Real-Time-Unique-Number (N2) using the first Public-Key (P1), the second Secret-Key (S2) and the cryptographic Function (F1);
authenticating the first user or the second user based on comparison of the Real-Time-Unique-Number (N2) with the first Unique-Number (N1); and
upon successful authentication, affixing the first biometric signature or the second biometric signature to the target document.

13. The method of claim 10, wherein storing the record on the blockchain comprises:
generating a cryptographic hash of the countersigned document;
generating transaction metadata comprising signatory identifiers, timestamps, device identifiers, and other transaction parameters;
generating a transaction record comprising the cryptographic hash and the transaction metadata; and
writing the transaction record on a blockchain for permanent immutable storage.

14. The method of claim 10, wherein the one or more biometric factors correspond to face, voice, retina, iris, fingerprint, and palm vein, wherein the business communication address comprises an email address or a phone number, wherein the customer communication address comprises a proxy email address or a proxy phone number, and wherein the hashing algorithm corresponds to a one-way hash function.

15. The method of claim 10, wherein transmitting via the encrypted communication channel occurs within a messaging group environment configured with permissioning rules that define which users may view, comment on, endorse, recommend, edit, or sign the target document, and wherein the messaging group environment supports sequential and non-sequential signing workflows and role-based permissions for multiple users.

16. The method of claim 10, further comprising re-authenticating at least one of the first user or the second user at a later time to verify the countersigned document by receiving verification biometric samples, processing the verification biometric samples to regenerate authentication data, and comparing the regenerated authentication data with stored authentication data to confirm validity of the countersigned document.

17. The method of claim 10, wherein the first biometric signature and the second biometric signature are each derived from a one-way hash of the respective biometric data combined with a unique nonce generated at the time of signing, wherein receiving the target document comprises receiving a document signing request generated upon scanning a machine-readable code, and further comprising blocking all subsequent communication attempts if the communication address hash does not match with the business-customer communication address hash.

18. The method of claim 10, wherein the method is performed across a distributed messaging network, and wherein every user action within the network is biometrically authenticated, cryptographically signed, and recorded on a blockchain.

19. A non-transitory computer-readable medium storing instructions that, when executed by a processor, perform the method of executing biometrically signed cryptographically verifiable blockchain-anchored contracts on a privacy-aware messaging platform, wherein the instructions comprise programmed code for:
registering a first user based on a user registration process;
registering a business entity by receiving and storing a business communication address associated with the business entity;
creating a business-customer account by:
generating a cryptographic key-value pair comprising a customer public key and a customer private key,
creating a customer communication address for the first user,
generating a business-customer communication address hash by applying a hashing algorithm to a combination of the business communication address and the customer communication address, and
generating a record in memory comprising the business-customer communication address hash and the customer public key;
receiving a target document from the first user;
affixing a first biometric signature to the target document by biometrically authenticating the first user and, upon successful authentication, affixing the first biometric signature;
transmitting the target document with the first biometric signature to a second user registered based on the user registration process, wherein the target document is transmitted via an encrypted communication channel by:
extracting communication addresses from a communication request,
generating a communication address hash using the hashing algorithm based on a combination of the communication addresses,
comparing the communication address hash with the business-customer communication address hash from the record,
upon matching, encrypting the target document using the customer public key, and
transmitting the encrypted target document to the second user, and biometrically authenticating the second user, upon receipt of the target document by the second user;
presenting the target document to the second user upon successful authentication;
affixing to the target document a second biometric signature by the second user,
transmitting a countersigned document comprising the first biometric signature and the second biometric signature, back to the first user, via the encrypted communication channel; and
storing a record of the countersigned document on a blockchain.
